(19) United States
(12) Patent Application Publication
(10) Pub. No.: US 2025/0341802 A1
(43) Pub. Date: Nov. 6, 2025

(54) IMAGE FORMING APPARATUS

(71) Applicant: CANON KABUSHIKI KAISHA, Tokyo (JP)

(72) Inventor: YASUKI KAMIMORI, Chiba (JP)

(21) Appl. No.: 19/184,078

(22) Filed: Apr. 21, 2025

(30) Foreign Application Priority Data
May 4, 2024 (JP) 2024-075011

(51) Int. Cl. G03G 21/00; G03G 15/00; G03G 21/08

(52) U.S. Cl. CPC G03G 21/0035; G03G 15/5004; G03G 15/55; G03G 21/0011; G03G 21/0076; G03G 21/08

(57) ABSTRACT

An image forming apparatus includes a photosensitive drum, a charging device, a charge bias applying portion, a transfer device, a transfer bias applying portion, a cleaning blade in contact with the surface of the photosensitive member at a blade cleaning position downstream of a transfer position and upstream of a charging position, a rotatable brush in contact with the surface at a brush cleaning position downstream of the transfer position and upstream of a blade cleaning position, and a cleaning bias applying portion. A controller during non-image formation, causes the cleaning bias applying portion to apply test biases to the brush and to perform a setting operation in which a voltage to be applied by the cleaning bias applying portion is set based on a detecting result of a current flowing through the brush or a voltage applied to the brush when test biases are applied.

### FIELD OF THE INVENTION AND RELATED ART

The present invention relates to an image forming apparatus, such as a copying machine, a printer, or a facsimile machine, using an electrophotographic type.

Conventionally, in the image forming apparatus of the electrophotographic type, a toner image formed on a surface of a photosensitive member through steps of charging, exposure, and development is directly transferred onto a recording material or is transferred onto the recording material through an intermediary transfer member. On a surface of the photosensitive member on which a transfer step of the toner image from the photosensitive member onto the recording material or the intermediary transfer member which are transfer receiving members is ended, untransferred toner (transfer residual toner), an external additive of the toner, an electric discharge product, and the like remain. For that reason, there is a need to remove these from the surface of the photosensitive member in advance of a subsequent image forming process. As a method for removing the transfer residual toner and the like from the surface of the photosensitive member, various methods such as a method using a fur brush, a magnetic brush, or the like, and a method using a cleaning blade are used. Of these methods, the method in which the transfer residual toner is scraped off from the surface of the photosensitive member by rubbing the surface of the photosensitive member with the cleaning blade has been more widely used since it has a relatively simple constitution and is inexpensive.

With speed-up and image quality improvement of the image forming apparatus in recent years, the toner has a lower melting point and is closer in shape to a sphere, so that it has become difficult to ensure a cleaning property using only the cleaning blade.

Therefore, there is a method in which an auxiliary cleaning means for assisting removal of the transfer residual toner by using the cleaning blade. For example, a method in which the fur brush (brush roller) which contacts the surface of the photosensitive member is provided upstream of the cleaning blade with respect to a movement direction of the surface of the photosensitive member has been proposed (Japanese Laid Open Patent Application (JP-A) 2023-26989).

By applying a bias to the fur brush, at least a part of the transfer residual toner before it reaches the cleaning blade can be removed from the surface of the photosensitive member by the fur brush. This maintains a stable deposit of the external additive of the toner (herein also referred to as “external additive dam layer”) formed near a contact portion between the cleaning blade and the photosensitive member (herein also referred to as “blade nip”). As a result, the occurrence of a phenomenon in which toner present in the vicinity of the blade nip melts and adheres to the photosensitive member (herein also referred to as “toner fusion”) is suppressed.

Thus, in order to meet the recent demands for image forming apparatuses with higher speeds and longer lifetimes, the role of the fur brush as a cleaning auxiliary means for improving the cleaning property of the photosensitive member is becoming increasingly important.

However, as the accumulated usage amount of the fur brush increases, a collapse of the fiber (permanent deformation) occurs due to the influence of a member that penetrates (enters) and comes into contact with the fur brush (such as the photosensitive member to be cleaned and a collecting member that collects toner from the fur brush), causing the outer diameter of the fur brush to tend to become smaller. When the outer diameter of the fur brush is reduced, the contact width between the photosensitive member and the fur brush with respect to the movement direction of the surface of the photoconductor is reduced, and the contact resistance (electrical resistance) between the photosensitive member and the fur brush increases.

Therefore, if the value of a bias applied to the fur brush is fixed at a predetermined voltage value, the value of the current flowing through the fur brush decreases as the accumulated usage amount of the fur brush increases.

As a result, the current (cleaning current) required for collecting the toner does not flow between the fur brush and the photosensitive member, and the toner cleaning property of the fur brush decreases. When the toner cleaning property of the fur brush decreases, the toner may slip through the fur brush and destroy the external additive dam layer that has accumulated near the cleaning blade. This may cause the toner present in the vicinity of the blade nip to melt, resulting in toner fusion. On the other hand, if the bias value applied to the fur brush is set high in anticipation of the decrease in the outer diameter of the fur brush, an excessive current may flow between the fur brush and the photosensitive member in the initial stage of use of the fur brush. This can cause a phenomenon known as “positive memory” to occur in the photosensitive member. Positive memory is a phenomenon in which, when the normal charge polarity of a photosensitive member is negative, the photosensitive member becomes positive which is the polarity opposite to the normal charge polarity, and the photosensitive member cannot be uniformly charged to a predetermined negative charging potential during the charging process, resulting in image defects such as density unevenness in the image.

### SUMMARY OF THE INVENTION

Therefore, an object of the present invention is to make it possible to apply an appropriate bias to the fur brush regardless of the accumulated usage amount of the fur brush, while suppressing charging failure of a photosensitive member caused by applying a bias to the fur brush.

The above object can be achieved by an image forming apparatus pertaining to the present invention. In summary, the present invention relates to an image forming apparatus comprising: a rotatable photosensitive member; a charging device configured to charge a surface of the photosensitive member at a charging position; a charge bias applying portion configured to apply a charging bias, for charging the surface of the photosensitive member, to the charging device; a transfer device configured to transfer toner to a transferred member from the surface of the photosensitive member at a transfer position; a transfer bias applying portion configured to apply a transfer bias, for transferring the toner to the transferred member from the photosensitive member, to the transfer device; a cleaning blade in contact with the surface of the photosensitive member at a blade cleaning position downstream of the transfer position and upstream of the charging position with respect to a rotational direction of the photosensitive member and configured to remove the toner from the surface of the photosensitive member; a rotatable brush in contact with the surface of the photosensitive member at a brush cleaning position downstream of the transfer position and upstream of the blade cleaning position with respect to the rotational direction of the photosensitive member and configured to remove the toner from the surface of the photosensitive member; a cleaning bias applying portion configured to apply a cleaning bias to the brush; a detecting portion configured to detect a current flowing through the brush or a voltage applied to the brush; and a control portion, during non-image formation, configured to cause the cleaning bias applying portion to apply a plurality of test biases to the brush and to perform a setting operation in which a voltage to be applied by the cleaning bias applying portion is set based on a detecting result by the detecting portion when the plurality of test biases are applied.

Further features of the present invention will become apparent from the following description of exemplary embodiments with reference to the attached drawings.

### BRIEF DESCRIPTION OF THE DRAWINGS

FIG. 1 is a cross-sectional schematic view of an image forming apparatus.

FIG. 2 is a cross-sectional schematic view of an image forming portion.

FIG. 3 is a schematic block diagram showing a control configuration of the image forming apparatus.

FIG. 4 is a schematic sectional view of the periphery of a cleaning device.

FIG. 5 is a schematic view for explaining an occurrence process of toner fusion.

FIG. 6 is a schematic view for explaining an effect of suppressing toner fusion.

FIG. 7 is a graph showing the change in the outer diameter of a fur brush.

FIG. 8 is a graph showing the change in current flowing through the fur brush.

FIG. 9 is a graph showing the change in a toner cleaning property by the fur brush.

FIG. 10 is a graph showing the relationship between a cleaning bias and a potential of a photosensitive drum.

FIG. 11 is a flow chart showing a control procedure for a setting operation of the cleaning bias in an embodiment 1.

FIG. 12 is a graph showing the relationship between a pre-brush potential and a threshold value making positive potential.

FIG. 13 is a graph showing a method for determining a voltage value of the cleaning bias.

Part (a) of FIG. 14 is a timing chart of operations during image formation and part (b) is a timing chart of operations during the setting operation.

FIG. 15 is a flow chart showing a control procedure for a setting operation of a cleaning bias in an embodiment 2.

FIG. 16 is a schematic sectional view of the periphery of the cleaning device in another example of the image forming apparatus.

### DESCRIPTION OF THE EMBODIMENTS

In the following, an image forming apparatus according to the present invention will be described specifically with reference to the drawings.

### Embodiment 1

### 1. General Structure and Operation of Image Forming Apparatus

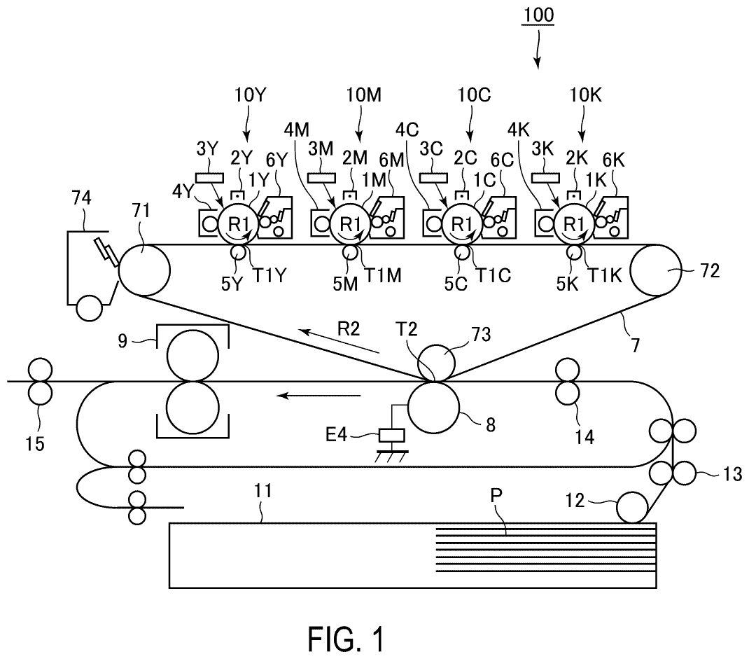

FIG. 1 is a schematic sectional view of an image forming apparatus 100 of an embodiment 1. The image forming apparatus 100 of this embodiment is a four-color based full-color printer of a tandem type in which a full-color image is capable of being formed by using an electrophotographic process and in which an intermediary transfer type is employed.

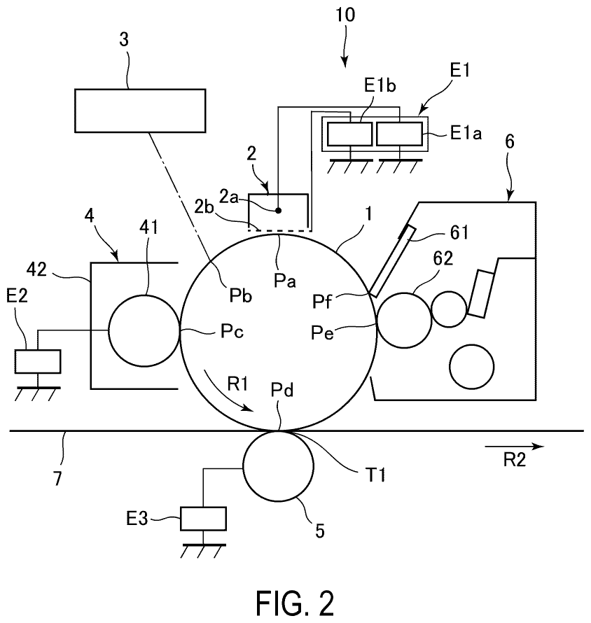

The image forming apparatus 100 includes, as a plurality of image forming portions (stations), four image forming portions 10Y, 10M, 10C, 10K for forming colors of yellow (Y), magenta (M), cyan (C) and black (K), respectively. These image forming portions 10Y, 10M, 10C and 10K are disposed in line along a movement direction of an image transfer surface, formed substantially horizontally, of an intermediary transfer belt 7 described later. Regarding elements having the same or corresponding functions or constitutions in the respective image forming portions 10Y, 10M, 10C and 10K, these elements are collectively described in some instances by omitting suffixes, Y, M, C and K of reference numerals or symbols representing the elements for associated colors. FIG. 2 is a schematic sectional view showing a single image forming portion 10 as a representative. In this embodiment, the image forming portions 10 are constituted by including photosensitive drums 1 (1Y, 1M, 1C, 1K), charging devices 2 (2Y, 2M, 2C, 2K), exposure devices 3 (3Y, 3M, 3C, 3K), developing devices 4 (4Y, 4M, 4C, 4K), primary transfer rollers 5 (5Y, 5M, 5C, 5K), cleaning devices 6 (6Y, 6M, 6C, 6K), and the like which are described later.

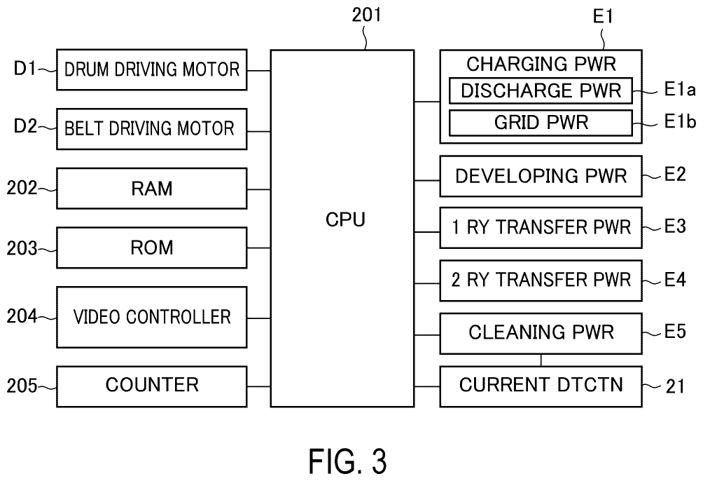

The image forming apparatus 100 includes, as a first image bearing member for bearing a toner image, the photosensitive drum 1 which is a rotatable drum type (cylindrical) photosensitive member (electrophotographic photosensitive member). The photosensitive drum 1 is rotated (rotationally driven) at a predetermined peripheral speed (process speed) in an arrow R1 direction (counterclockwise direction) in FIG. 1 by transmission thereto a driving force from a drum driving motor D1 (FIG. 3) which is a driving source constituting a driving device as a driving means. A surface of the rotating photosensitive drum 1 is electrically charged uniformly to a predetermined polarity (negative in this embodiment) and a predetermined potential by the charging device 2 as a charging means. During the charging process, to the charging device 2, a predetermined charging bias (charging voltage) is applied by a charging power source (high-voltage power source) E1 as a charging bias applying portion.

The charged surface of the photosensitive drum 1 is subjected to scanning exposure to light depending on an image signal by the exposure device 3 as an exposure means, so that an electrostatic latent image (electrostatic image) is formed on the photosensitive drum 1. The electrostatic latent image formed on the photosensitive drum 1 is developed (visualized) by being supplied with toner as a developer by the developing device 4 as a developing means, so that a toner image (developer image) is formed on the photosensitive drum 1. In this embodiment, on an image portion of the photosensitive drum 1 where an absolute value of a potential is lowered through exposure to light after the uniform charging process, the toner charged to the same polarity (negative in this embodiment) as a charge polarity of the photosensitive drum 1 is deposited (reverse development type). During development, to a developing sleeve 41 of the developing device 4, a predetermined developing bias (developing voltage) is applied by a developing power source (high-voltage power source) E2 as a developing bias applying portion. In this embodiment, a normal charge polarity of the toner which is the charge polarity of the toner during the development is the negative (−) polarity.

The intermediary transfer belt 7, which is a rotatable intermediary transfer member, constituted by an endless belt as a second image bearing member for bearing the toner image is provided so as to oppose the four photosensitive drums 1Y, 1M, 1C and 1K. The intermediary transfer belt 7 is extended around, as a plurality of stretching rollers (support rollers), a driving roller 71, a tension roller 72, and a secondary transfer opposite roller 73 and is stretched with predetermined tension. A driving force is transmitted from a belt driving motor D2 (FIG. 3) which is a driving source constituting the driving device as a driving means to the intermediary transfer belt 7, and the driving roller 71 is rotationally driven and thus the intermediary transfer belt 7 is rotated (circulated and moved) at a predetermined peripheral speed (process speed) corresponding to the peripheral speed of the photosensitive drums 1 in an arrow R2 direction (clockwise direction). On an inner peripheral surface side of the intermediary transfer belt 7, the primary transfer rollers 5Y, 5M, 5C and 5K which are roller-shaped primary transfer members (transfer devices) as primary transfer means are provided correspondingly to the photosensitive drums 1Y, 1M, 1C and 1K, respectively. The primary transfer roller 5 is pressed toward the photosensitive drum 1 and is contacted to the photosensitive drum 1 via the intermediary transfer belt 7, and forms a primary transfer portion (primary transfer nip) T1 which is a contact portion between the photosensitive drum 1 and the intermediary transfer belt 7. The stretching rollers, of the plurality of stretching rollers, other than the driving roller 71, and the respective primary transfer rollers 5 are rotated with the rotation of the intermediary transfer belt 7. The toner image formed on the photosensitive drum 1 is transferred (primary-transferred) onto the rotating intermediary transfer belt 7 by the action of the primary transfer roller in the primary transfer portion T1. During the primary transfer, to the primary transfer roller 5, a predetermined primary transfer bias (primary transfer voltage) which is a DC voltage of a polarity (positive in this embodiment) opposite to the normal charge polarity of the toner is applied by a primary transfer power source (high-voltage power source) E3 as a primary transfer bias applying portion. For example, during full-color image formation, toner images of yellow, magenta, cyan and black formed on the respective photosensitive drums 1 are successively primary-transferred superposedly onto the intermediary transfer belt 7.

On an outer peripheral surface side of the intermediary transfer belt 7, in a position opposing the secondary transfer opposite roller 73, a secondary transfer roller 8 which is a roller-shaped secondary transfer member as a secondary transfer means is provided. The secondary transfer roller 8 is pressed toward the secondary transfer opposite roller 73 and is contacted to the secondary transfer opposite roller 73 via the intermediary transfer belt 7 and forms a secondary transfer portion (secondary transfer nip) T2 which is a contact portion between the intermediary transfer belt 7 and the secondary transfer roller 8. In this embodiment, the secondary transfer roller 8 is rotated with the rotation of the intermediary transfer belt 7. However, the secondary transfer roller 8 may be constituted to be rotationally driven by the driving force transmitted from the driving source. The toner image formed on the intermediary transfer belt 7 is transferred (secondary-transferred) onto a recording material P nipped and fed by the intermediary transfer belt 7 and the secondary transfer roller 8 by the action of the secondary transfer roller 8 in the secondary transfer portion T2. During the secondary transfer, to the secondary transfer roller 8, a predetermined secondary transfer bias (secondary transfer voltage) which is a DC voltage of the polarity (positive in this embodiment) opposite to the normal charge polarity of the toner is applied by a secondary transfer power source (high-voltage power source) E4 as a secondary transfer bias applying portion. The secondary transfer opposite roller 73 is electrically grounded (connected to the ground). Incidentally, a roller corresponding to the secondary transfer opposite roller 73 in this embodiment may be used as a secondary transfer member, and to this roller, a secondary transfer voltage of the same polarity as the normal charge polarity of the toner may be applied. In this case, a roller corresponding to the secondary transfer roller 8 in this embodiment may only be required to be used as an opposite electrode and to be electrically grounded. The recording material (transfer material, recording medium, sheet) P such as paper or a plastic sheet is accommodated in a recording material cassette 11 as a recording material accommodated portion. The recording material P accommodated in the recording material cassette 11 is separated and fed one by one from the recording material cassette 11 by a feeding roller 12 or the like as a feeding means. This recording material P is conveyed toward a registration roller pair 14 as a conveying means by a conveying roller pair 13 as a conveying means. Then the recording material P is timed to the toner image on the intermediary transfer belt 7 and is conveyed toward the secondary transfer portion T2 by the registration roller pair 14.

The recording material P on which the toner image is transferred is conveyed to a fixing device 9 as a fixing means. The fixing device 9 fixes (melts, sticks) the toner image on the surface of the recording material P by heating and pressing the recording material P, on which the unfixed toner image is carried, through nipping and conveyance of the recording material P by a rotatable fixing member pair.

The recording material P on which the toner image is fixed is discharged (outputted) onto a discharge tray (not shown) or the like provided on an outside of an apparatus main assembly of the image forming apparatus 100 by a discharging roller pair 15 as a discharging means.

On the other hand, a deposited matter such as toner (primary-transfer residual toner) remaining on the photosensitive drum 1 after the primary transfer is removed and collected from the surface of the photosensitive drum 1 by the cleaning device 6 as a cleaning means. Further, a deposited matter such as the toner (secondary transfer residual toner) remaining on the intermediary transfer belt 7 after the secondary transfer is removed and collected from the surface of the intermediary transfer belt 7 by a belt cleaning device 74 as an intermediary transfer member cleaning means.

Here, with respect to a rotational direction of the photosensitive drum 1, a position on the photosensitive drum 1 where the charging process is performed by the charging device 2 is a charging position (charging portion) Pa. Further, with respect to the rotational direction of the photosensitive drum 1, a position on the photosensitive drum 1 where the photosensitive drum surface is irradiated with light emitted by the exposure device 3 is an exposure position (exposure portion) Pb. Further, with respect to the rotational direction of the photosensitive drum 1, a position (opposing portion to the developing sleeve 41) on the photosensitive drum 1 to which the toner is supplied by the developing device 4 is a developing position (developing portion) Pc. Further, with respect to the rotational direction of the photosensitive drum 1, a position (corresponding to the above-described primary transfer portion T1 which is the contact portion with the intermediary transfer belt 7) on the photosensitive drum 1 where the primary transfer of the toner image onto the intermediary transfer belt 7 is carried out is a primary transfer position Pd. Further, with respect to the rotational direction of the photosensitive drum 1, a position (contact portion with a fur brush 62) on the photosensitive drum 1 where removal of the transfer residual toner is made by the fur brush 62 of the cleaning device 6 described later is a brush cleaning position (brush cleaning portion) Pe. Further, with respect to the rotational direction of the photosensitive drum 1, a position (contact portion with a cleaning blade 61) on the photosensitive drum 1 where removal of the transfer residual toner is made by the cleaning blade 61 of the cleaning device 6 described later is a blade cleaning position (blade cleaning portion) Pf. With respect to the rotational direction of the photosensitive drum 1, the charging position Pa, the exposure position Pb, the developing position Pc, the primary transfer position Pd, the brush cleaning position Pe, and the blade cleaning position Pf are positioned in a named order from an upstream side toward a downstream side as viewed from the charging position Pa.

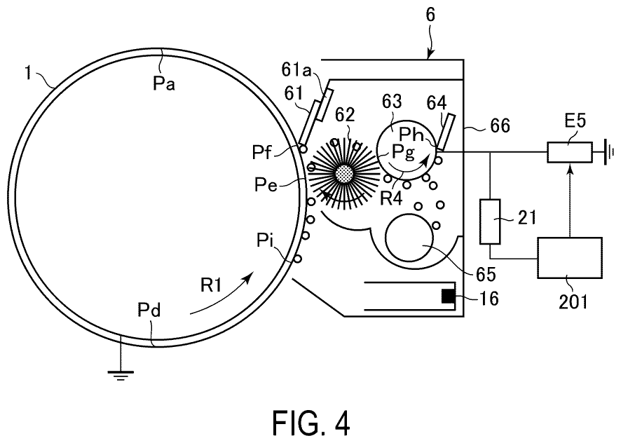

Incidentally, in this embodiment, a pre-cleaning discharging device (pre-cleaning charge eliminating device) 16 (FIG. 4) is provided in the image forming portion 10, and the pre-cleaning discharging device 16 will be described later.

FIG. 3 is a schematic block diagram showing a control configuration of the image forming apparatus 100 in this embodiment. The image forming apparatus 100 includes a CPU 201 as a control means (controller) for controlling the image forming apparatus 100. To the CPU 201, a RAM 202 as a storing means (storing portion) used as a memory for operation and a ROM 203 as a storing means (storing portion) in which programs executed by the CPU 201 and various data are stored are connected. Further, to the CPU 201, a video controller 204 for processing image forming information inputted to the image forming apparatus 100 is connected. The video controller 204 for processing the image information processes the image information inputted from an external device (not shown) such as a personal computer (PC) or an image reader, connected to the image forming apparatus 100. The CPU 201 controls the respective portion of the image forming apparatus 100 on the basis of image information processed and generated by the video controller 204. That is, the image forming apparatus 100 forms and outputs (prints out) the toner image corresponding to the image information inputted to the CPU 201 on the recording material P.

The CPU 201 is connected to various power sources such as the charging power source E1, the developing power source E2, the primary transfer power source E3, the secondary transfer power source E4, and a cleaning power source E5 which will be described later. Further, the CPU 201 is connected to various driving sources (driving devices) such as the drum driving motor D1 and the belt driving motor D2. Further, various sensors such as a current detecting portion 21, which will be described later, are connected to the CPU 201. The CPU 201 exchanges signals with each of these portions to control an image forming operation and a setting operation of a cleaning bias which will be described later.

Incidentally, although illustration is omitted, in this embodiment, the charging power source E1, the developing power source E2, the primary transfer power source E3, and the cleaning power source E5 are provided independently for each image forming portion 10. However, at least one of these power sources may be common to all or some of the image forming portions 10. Further, although illustration is omitted, in this embodiment, the drum driving motor D1 is provided independently for each photosensitive drum 1. However, the drum driving motor D1 may be common to all or some of the photosensitive drums 1. Further, at least one of the drum driving motors may be shared with the belt driving motor.

Further, the image forming apparatus 100 executes a job (image output operation, print job) which is a series of operations that is started by one start instruction and forms and outputs an image on one or a plurality of recording materials P. A job generally includes an image formation step, a pre-rotation step, an inter-sheet step in the case where images are formed on a plurality of recording materials P, and a post-rotation step. The image formation step is the period during which the electrostatic image of the image to be actually formed and outputted on the recording material P is formed, the toner image is formed, and the toner image is primarily-transferred and secondary-transferred, and this is referred to as a time of image formation (image formation period). More specifically, the timing of image formation differs depending on the position where each of the steps of electrostatic image formation, toner image formation, and primary transfer and secondary transfer of the toner image is performed. The pre-rotation step is a period during which preparatory operations are performed prior to the image formation step, from when the start instruction is inputted until the actual start of image formation. The inter-sheet step is a period corresponding to the interval between recording materials P when image formation is continuously performed on a plurality of recording materials P (continuous image formation). The post-rotation step is a period in which a rearranging operation (preparatory operation) is performed after the image formation step. Non-image formation (non-image formation period) refers to a period other than image formation and includes the above-described pre-rotation, inter-sheet, and post-rotation steps, as well as a pre-multiple rotation step which is the preparatory operation when the image forming apparatus 100 is turned on or when it returns from a sleep state.

### 2. Detailed Constitutions of Respective Portions

Next, detailed constitutions of the respective portions of the image forming apparatus 100 will be described. Incidentally, the cleaning device 6 and the pre-cleaning discharging device 16 will be described later.

### <Charging Device>

In this embodiment, as the charging means, the charging device 2 of a corona charging type was used. The charging device 2 of the corona charging type includes a discharge electrode 2a and a grid electrode 2b, and a high voltage is applied to the discharge electrode 2a and the grid electrode 2b, so that the surface of the photosensitive drum 1 is electrically charged uniformly by utilizing a discharge phenomenon. In this embodiment, during image formation, for example, by a discharging power source Ela of the charging power source E1, a voltage is applied to the discharge electrode 2a so that a current of −1000 ρA flows, and a voltage of −600 V is applied to the grid electrode 2b by a grid power source portion E1b of the charging power source E1. By this, the surface of the rotating photosensitive drum 1 is uniformly charged to a surface potential (charge potential, non-image portion potential) of about-500 V. Incidentally, the charging device 2 may charge at least an image forming area (area where the toner image can be formed) on the photosensitive drum 1 with respect to a rotational axis direction of the photosensitive drum 1. In this embodiment, the charging device 2 charges an almost entire area with respect to the rotational axis direction of the photosensitive drum 1. In this embodiment, the charge potential of the photosensitive drum 1 has the negative polarity, and the surface of the photosensitive drum 1 is charged to the negative polarity side. Incidentally, the charge potential of the photosensitive drum 1 may be changed in conformity to, for example, a value of the developing bias, on the basis of an environment, a state of the image forming apparatus 100, or the like.

Incidentally, the charging means is not limited to the charging device of the corona charge type. For example, as the charging means, a contact-type charging roller contactable to the surface of the photosensitive drum 1 may be used. In this case, the surface of the photosensitive drum 1 is charged by utilizing the discharge phenomenon generating in a small gap between the photosensitive drum 1 and the charging roller. Further, in this case, to a core metal of the charging roller, a charging bias in a predetermined condition is applied. As this charging bias, an oscillating voltage in the superposed form of a DC component (DC bias) and an AC component (AC bias) can be used. For example, by setting the DC bias at −500 V and the AC bias at a peak-to-peak voltage value which is not less than twice a discharge start voltage in the case where the DC voltage is applied in the environment, the surface of the photosensitive drum 1 can be uniformly charged to about-500 V.

### <Exposure Device>

In this embodiment, as the exposure device 3, a laser scanner was used. The exposure device 3 includes a semiconductor laser as a light source, and subjects the photosensitive drum 1, of which surface is charged uniformly by the charging device 2, to image exposure on the basis of the image information. A surface potential (exposure potential, image portion potential) of the photosensitive drum 1 formed by irradiating the photosensitive drum surface with the laser light by the exposure device 3 is about-200 V.

Incidentally, in this embodiment, an example in which the exposure means uses the semiconductor laser as the light source will be described, but the exposure means may also use another light source as the light source such as an LED.

Further, for example, a potential measuring means capable of measuring the surface potential of the photosensitive drum 1 after the exposure is disposed in the image forming apparatus 100, and whether or not the charge potential and the exposure potential actually become predetermined potentials can be made so as to be capable of being checked.

### <Developing Device>

In this embodiment, the developing device 4 of the reverse development type using a two-component developer was used as the developing means. The developing device 4 includes a developing container 42 in which as the developer, the two-component developer which is a mixture principally between non-magnetic toner particles (toner) and magnetic carrier particles (carrier) is accommodated. Further, the developing device 4 includes the developing sleeve 41 as a developer carrying member (developing member) provided rotatably at an opening of this developing container 42. In this embodiment, as the toner, negatively chargeable toner (negative toner) was used. In this embodiment, a length of the developing sleeve 41 with respect to a rotational axis direction is 325 mm. The developing sleeve 41 is rotationally driven by transmission thereto a driving force from a driving motor as a driving source. Incidentally, to the developing sleeve 41, the driving force may be transmitted from a dedicated driving source or the driving force may be branched and transmitted from the driving source for the other rotatable member such as the driving source for the photosensitive drum 1. In this embodiment, the developing sleeve 41 is rotationally driven by the driving force transmitted from the drum driving motor D1. The developing sleeve 41 magnetically holds the developer in the developing container 42 by the action of a magnet (not shown) fixed and disposed inside the developing sleeve 41 and conveys the developer to a developing portion which is a gap portion with the photosensitive drum 1. In this embodiment, to the developing sleeve 41, by the developing power source E2, as the developing bias, an oscillating voltage in the superposed form of the DC component (DC bias) and the AC component (AC bias) is applied. For example, a developing bias in the superposed form of a DC bias of −400 V and an AC bias of 1600 V in Vpp is applied to the developing sleeve 41. By this developing bias, the development is carried out by deposition of the toner on the electrostatic latent image. Incidentally, a set value of the above-described developing bias is an example and the developing bias can be set at an appropriately adjusted value depending on the charge potential or the exposure potential of the photosensitive drum 1.

### <Intermediary Transfer Belt>

In this embodiment, as the intermediary transfer member, the endless belt-shaped intermediary transfer belt 7 was used. In this embodiment, the intermediary transfer belt 7 includes three layers consisting of a resin layer, an elastic layer, and a surface layer in a named order from a back surface side (inner peripheral surface side) toward a front surface side (outer peripheral surface side). As a resin material constituting the resin layer, a material such as polyimide or polycarbonate is used. A thickness of the resin layer may preferably be 70 μm or more and 100 μm or less. Further, as an elastic material constituting the elastic layer, a material such as an urethane rubber or a chloroprene rubber is used. A thickness of the elastic layer may preferably be 200 μm or more and 250 μm or less.

Further, as a material constituting the surface layer, a material capable of improving a secondary transfer property by decreasing a depositing force of the toner onto the surface of the intermediary transfer belt 7 may preferably be used. For example, one species of the resin material such as polyurethane, polyester, or epoxy resin, or two or more species of materials of elastic materials (elastic material rubber, elastomer), butyl rubber, and the like are used as a base material. Further, in this base material, one species or two or more species of materials for enhancing a lubricating property by decreasing surface energy, such as powder or particles of fluorine-containing resin, or materials thereof made different in particle size can be dispersed and used. A thickness of the surface layer may preferably be 5 μm or more and 10 μm or less. In this embodiment, as the intermediary transfer belt 7, an intermediary transfer belt in which an electroconductive agent for adjusting an electric resistance value, such as carbon black is added and thus volume resistivity is 1×10⁸ Ω·cm or more and 1×10¹⁴ Ω·cm or less.

### <Primary Transfer Roller>

In this embodiment, as the primary transfer means, the primary transfer roller 5 which is a roller prepared by molding a hydrin rubber elastic layer, adjusted in electric resistance, around a metal shaft was used. The primary transfer roller 5 is disposed in a position shifted to a downstream side with respect to the movement direction of the surface of the intermediary transfer belt 7 by about 2 mm from a position of a rotation center of the photosensitive drum 1, and is pressed toward the photosensitive drum 1 with a predetermined pressing force. To the primary transfer roller 5, the primary transfer bias is applied, so that the toner image is transferred from the photosensitive drum 1 onto the intermediary transfer belt 7. At that time, not only the toner but also the carrier in a small amount exist on the photosensitive drum 1 in some cases. As described above, by providing the elastic layer in the intermediary transfer belt 7, even when a hard material high in hardness such as the carrier is caught in the primary transfer portion T1, an effect such that damage on the photosensitive drum 1 in the primary transfer portion T1 is reduced can be obtained.

### <Toner>

In this embodiment, the toner is triboelectrically charged to the negative polarity by rubbing with the carrier. In this embodiment, as the carrier, a carrier containing ferrite and having an average particle size of about 40 μm was used. Further, in this embodiment, as the toner, toner which is obtained by subjecting, to pulverization and classification, a kneaded product of a pigment and a wax component in a resin binder principally comprising polyester and which has an average particle size of about 6 μm was used. Further, in this embodiment, for the purposes of charge control, impartation of flowability, improvement in transfer property, and the like, on the surface layer of the toner, a plurality species of external additive components (external additives) are deposited. In this embodiment, as the external additive component, in addition to silica and titanium oxide, inorganic fine particles which are 30 nm or more and 300 nm or less in average particle size of primary particles, which have at least one of a cubic particle shape and a rectangular parallelopiped particle shape, and which include a perovskite-type crystal were externally added. In this embodiment, strontium titanate fine powder was externally added as the inorganic fine particles including the perovskite-type crystal. The external additive component may preferably be added to toner particles in an amount of 0.05 wt. part or more and 2.00 wt. parts or less per 100 wt. parts of final toner particles before the external additive component is added to the toner particles, and in this embodiment, the strontium titanate fine powder was externally added in an amount of 0.5 wt. part. The strontium titanate fine powder used as the inorganic fine particles may more preferably be particles which are not subjected to a sintering step.

Here, an average particle size (number-average particle size) of the primary particles of the above-described inorganic fine particles (external additive) can be acquired by observing the inorganic fine particles existing on toner particle surfaces through a scanning electron microscope. As the scanning electron microscope, a Hitachi Ultra-High Resolution Field Emission Scanning Electron Microscope S-4800 (manufactured by Hitachi, Ltd.) can be used. Incidentally, elementary analysis of an energy dispersive X-ray analyzer (manufactured by EDAX Inc.) is made in advance, and then a material of an associated particle is checked, so that measurement can be performed. For example, in an enlarged field of view magnified by 50,000 times at the maximum, a long diameter of 100 primary particles of the inorganic fine particles are randomly measured, so that the number-average particle size can be acquired. An observation magnification can be appropriately adjusted depending on the size of the inorganic fine particles.

Further, an average particle size (weight-average particle size) of the above-described toner can be calculated by measuring the particle size of the toner by a precise particle size distribution measuring device “Multisizer 3 Coulter Counter” (registered trademark, manufactured by Beckman Coulter, Inc.), according to a small-pore electric resistance method, provided with a 100 μm-aperture tube and a dedicated software “Beckman Coulter Multisizer 3 Version 3.51” (manufactured by Beckman Coulter, Inc.) included with the measuring device for measuring condition setting and measured data analysis, and then by performing the measured data analysis. Incidentally, it can be said that toner of about 4 μm or more and about 8 μm or less in average diameter is small particle size toner.

### <Photosensitive Drum>

In this embodiment, as the photosensitive member, the photosensitive drum 1 which is a negatively chargeable organic photoconductor (OPC) and which has a length of 360 mm and an outer diameter of 84 mm with respect to a rotational axis direction was used. In this embodiment, the photosensitive drum 1 is constituted by including an electroconductive substrate and a photosensitive layer which is formed thereon and which includes a photo-conductive layer principally comprising an organic photoconductor. The OPC is constituted in general by laminating, on a metal substrate as the electroconductive substrate, a charge generating layer, a charge transporting layer, and a surface protective layer which are each formed of an organic material, in a named order. In this embodiment, as the photosensitive drum 1, for example, a photosensitive drum in which each of the above-described layers is formed of a material disclosed in Japanese Laid-Open Patent Application (JP-A) 2005-43806 was used. Further, in this embodiment, the photosensitive drum 1 of a type in which the surface of the topmost layer is cured by using, for example, an electron beam irradiation device (“EC150/45/40 mA”, manufactured by IWASAKI ELECTRIC CO., LTD.).

An elastic deformation rate of the surface of the photosensitive drum 1 (for example, the photosensitive drum 1 of the type the surface of the topmost layer is cured by the above-described electron beam) may preferably be 48% or more and 65% or less. Further, a universal hardness value (HU) of the surface of this photosensitive drum 1 may preferably be 150 N/mm² or more and 220 N/mm² or less. In the case where the elastic deformation rate is smaller than the above-described range or in the case where the universal hardness value (HU) is smaller than the above-described range, scars are liable to occur on the surface of the photosensitive drum 1 or the like, so that lifetime extension becomes difficult. Further, in the case where the elastic deformation rate is larger than the above-described range or in the case where the universal hardness value (HU) is larger than the above-described range, an abrasion amount of the surface of the photosensitive drum 1 becomes excessively small, so that toner fusion of the surface of the photosensitive drum 1 is liable to occur.

Further, in this embodiment, during image formation, the photosensitive drum 1 is rotationally driven at a process speed (peripheral speed) of 400 mm/s in general by the driving device.

Here, the universal hardness value (HU) and the elastic deformation rate of the surface of the above-described photosensitive drum 1 are values measured (acquired by conducting a hardness test) by using a microhardness measuring device “FISCHERSCOPE H100V” (manufactured by FISCHER INSTRUMENTS K.K.) in an environment of a temperature of 23° C. and a relative humidity of 50% RH. This FISCHERSCOPE H100V is a device in which an indenter is contacted to a measuring object (peripheral surface of the photosensitive drum 1) and a load is continuously exerted on this indenter and in which hardness is continuously acquired by directly reading a pressing depth under the load. As the indenter, a Vickers quadrangular pyramid diamond indenter with an angle between opposite faces of 136° was used, and the indenter was pressed against the peripheral surface of the photosensitive drum 1. A final load continuously exerted on the indenter was set at 6 mN, and a time (retention time) in which a state in which the final load of 6 mN was exerted on the indenter was retained was 0.1 sec. Further, the number of measuring points was 273 points.

### 3. Cleaning Device

### <General Structure and Operation of Cleaning Device>

Next, the cleaning device 6 in this embodiment will be described further specifically. FIG. 4 is a schematic sectional view of the cleaning device 6 and a periphery thereof in this embodiment.

The cleaning device 6 includes a housing 66. Further, the cleaning device 6 includes the fur brush (electroconductive fur brush roller) 62 which is a rotatable roller-shaped brush having electroconductivity. The fur brush 62 functions as a toner scraping means (cleaning member) for scraping the toner off the photosensitive drum 1. Further, the fur brush 62 constitutes an auxiliary cleaning means (auxiliary cleaning member) for assisting removal of the toner from the surface of the photosensitive drum 1 by the cleaning blade 61 described later. The fur brush 62 is rotatably supported by the housing 66. A rotational axis direction of the fur brush 62 is substantially parallel to the rotational axis direction of the photosensitive drum 1. The fur brush 62 is provided so as to contact the surface of the photosensitive drum 1. In this embodiment, the fur brush 62 is disposed so that a penetration amount into the surface of the photosensitive drum 1 is 0.7 mm. Here, the above-described penetration amount can be represented by a value obtained by subtracting a distance (shortest distance) between a base material on a rotation shaft of the fur brush 62 described later and the photosensitive drum 1 from a length of brush fibers described later. To the fur brush 62, a driving force is transmitted from a driving motor as a driving source while the fur brush 62 contacts the surface layer of the photosensitive drum 1, so that the fur brush 62 is rotationally driven at a predetermined rotational speed (peripheral speed in the case where the brush fiber is not deformed by an external force) in an arrow R3 direction (clockwise direction) in FIG. 4. That is, the fur brush 62 is rotationally driven so as to move in the same direction as the photosensitive drum 1 in a contact portion between itself and the photosensitive drum 1. Incidentally, to the fur brush 62, the driving force may be transmitted from a dedicated driving source or may also be branched and then transmitted from a driving source for another rotatable member, such as the driving source for the photosensitive drum 1. In this embodiment, the fur brush 62 is rotationally driven by the driving force transmitted from the drum driving motor D1. Further, in this embodiment, the fur brush 62 is rotationally driven at a peripheral speed faster than the peripheral speed (surface movement speed) of the photosensitive drum 1. In this embodiment, the fur brush 62 is rotationally driven at the peripheral speed which is 110% of the peripheral speed of the photosensitive drum 1.

Further, the cleaning device 6 includes the cleaning blade (elastic cleaning blade) 61 which is a plate-like (blade-like) member formed of an elastic material. The cleaning blade 61 functions as a toner scraping means (cleaning member) for scraping the toner off the photosensitive drum 1. The cleaning blade 61 is fixed by an adhesive bonding or the like to a supporting member 61a formed with a metal plate or the like, and this supporting member 61a is fixed to the housing 66, so that the cleaning blade 61 is supported by the housing 66. A longitudinal direction of the cleaning blade 61 is substantially parallel to the rotational axis direction of the photosensitive drum 1. The cleaning blade 61 is provided so as to contact the surface of the photosensitive drum 1 at a contact portion (blade cleaning position Pf) downstream of the contact portion (brush cleaning position Pe) between the fur brush 62 and the photosensitive drum 1 with respect to the rotational direction of the photosensitive drum 1. That is, the fur brush 62 is disposed so as to contact the surface of the photosensitive drum 1 at the contact portion (the brush cleaning position Pe) upstream of the contact portion (the blade cleaning position Pf) between the cleaning blade 61 and the photosensitive drum 1 with respect to the rotational direction of the photosensitive drum 1. The cleaning blade 61 is disposed so that an edge portion (on the photosensitive drum 1 side) of a free end portion thereof which is one end portion with respect to a widthwise direction substantially perpendicular to the longitudinal direction is contacted to the photosensitive drum 1 at a predetermined pressure. Further, the cleaning blade 61 contacts the photosensitive drum 1 in a direction counter to the rotational direction of the photosensitive drum 1 so that a fixed end portion which is the other end portion thereof with respect to the widthwise direction is positioned on a side upstream of the above-described free end portion with respect to the rotational direction of the photosensitive drum 1.

Further, the cleaning device 6 includes a collecting roller 63 which is a rotatable roller-like member having electroconductivity. The collecting roller 63 functions not only as a collecting means (collecting member) for collecting the toner from the fur brush 62 but also as a voltage applying member (electroconductive member) for applying a voltage to the fur brush 62. The collecting roller 63 is rotatably supported by the housing 66. A rotational axis direction of the collecting roller 63 is substantially parallel to the rotational axis direction of the fur brush 62. The collecting roller 63 is disposed so as to contact the fur brush 62 on a side downstream of the contact portion between the fur brush 62 and the photosensitive drum 1 with respect to the rotational direction of the fur brush 62. A contact portion between the fur brush 62 and the collecting roller 63 with respect to the rotational direction of the collecting roller 63 is a collecting position Pg. To the collecting roller 63, a driving force is transmitted from a driving motor as a driving source while the collecting roller 63 contacts the fur brush 62, so that the collecting roller 63 is rotationally driven at a predetermined rotational speed (peripheral speed) in an arrow R4 direction (counterclockwise direction) in FIG. 4. That is, the collecting roller 63 is rotationally driven so as to move in the same direction as the fur brush 62 in a contact portion between itself and the fur brush 62. Incidentally, to the collecting roller 63, which is a rotatable member, the driving force may be transmitted from a dedicated driving source or may also be branched and then transmitted from a driving source for another rotatable member, such as the driving source for the photosensitive drum 1 or the fur brush 62. In this embodiment, the collecting roller 63 is rotationally driven by the driving force transmitted from the drum driving motor D1. Further, in this embodiment, the collecting roller 63 is rotationally driven at a peripheral speed faster than the peripheral speed of the fur brush 62. In this embodiment, the collecting roller 63 is rotationally driven at the peripheral speed which is 105% of the peripheral speed of the fur brush 62.

Further, the cleaning device 6 includes a scraper member 64 which is a plate-like (blade-like) member formed of an elastic material. The scraper member 64 functions as a removing means (removing member) for removing the toner on the collecting roller 63. The scraper member 64 is supported by the housing 66.

Incidentally, similarly as the cleaning blade 61, the scraper member 64 may be supported by the housing 66 via a supporting member. A longitudinal direction of the scraper member 64 is substantially parallel to the rotational axis direction of the collecting roller 63. The scraper member 64 is provided so as to contact the surface of the collecting roller 63 on a side downstream of the contact portion (collecting position Pg) between the collecting roller 63 and the fur brush 62 with respect to the rotational direction of the collecting roller 63. A contact portion between the collecting roller 63 and the scraper member 64 with respect to the rotational direction of the collecting roller 63 is a removal position Ph. The scraper member 64 is disposed so that an edge portion (on the collecting roller 63 side) of a free end portion thereof which is one end portion with respect to a widthwise direction substantially perpendicular to the longitudinal direction is contacted to the collecting roller 63 at a predetermined pressure. Further, the scraper member 64 contacts the collecting roller 63 in a direction counter to the rotational direction of the collecting roller 63 so that a fixed end portion which is the other end portion thereof with respect to the widthwise direction is positioned on a side upstream of the above-described free end portion with respect to the rotational direction of the collecting roller 63.

Further, the cleaning device 6 includes a feeding screw 65 as a feeding means. The feeding screw 65 is provided below the scraper member 64 with respect to a direction of gravitation. The feeding screw 65 feeds the toner, collected in the housing 66, along the rotational axis direction of the photosensitive drum 1, for example, from a front side of a paper surface toward a rear side in FIG. 4.

To the collecting roller 63, the cleaning power source (high-voltage power source) E5 as a cleaning bias applying portion constituting a potential switching means for the fur brush 62 is connected. Further, by the cleaning power source E5, a cleaning bias (cleaning voltage) can be applied to the collecting roller 63. Further, to the collecting roller 63, the current detecting portion (current detecting circuit) 21 as a current detecting means for detecting a current flowing through the collecting roller 63 (fur brush 62, cleaning power source E5) when the cleaning bias is applied to the collecting roller 63 from the cleaning power source E5, is connected. And, the cleaning power source E5 is connected to the CPU 201. The CPU 201 controls a timing when the cleaning bias is applied to the fur brush 62 and a cleaning bias value (potential, voltage value) to be applied to the fur brush 62. In this embodiment, the cleaning bias is applied under constant-voltage control. The cleaning power source E5 incorporates a voltage detecting portion (not shown) as a voltage detecting means and is capable of performing the constant-voltage control of an output voltage so that a voltage value detected by the voltage detecting portion is substantially constant. As described later specifically, in this embodiment, the CPU 201 controls the cleaning bias value (potential, voltage value) to be applied to the fur brush 62 based on a detecting result by the current detecting portion 21.

In this embodiment, during removal of the toner from the surface of the photosensitive drum 1, the cleaning bias which is a DC voltage of the positive polarity (+) opposite to the normal charge polarity of the toner is applied to the collecting roller 63 by the cleaning power source E5. More specifically, the above-described during the removal of the toner refers to when an image forming area on the photosensitive drum 1 with respect to the surface movement direction of the photosensitive drum 1, where area is defined correspondingly to the recording material P, passes through the brush cleaning position Pe. As described later specifically, as a material of the fur brush 62, an electroconductive material such as electroconductive fibers is used. Further, the fur brush 62 contacts the collecting roller 63 to which the cleaning bias is applied, so that the potential thereof becomes a potential somewhat smaller in absolute value than the cleaning bias applied to the collecting roller 63. Thus, the potential of the fur brush 62 becomes the potential of the positive polarity opposite to the normal charge polarity of the toner. By this, the toner on the surface of the photosensitive drum 1 is caught not only mechanically but also electrostatically by the fur brush 62 rubbing the surface of the photosensitive drum 1. For that reason, cleaning efficiency is further improved. Thus, at least a part of the toner on the surface of the photosensitive drum 1 is collected by the fur brush 62 before reaches the cleaning blade 61.

The toner moved from the surface of the photosensitive drum 1 to the fur brush 62 in the contact portion between the photosensitive drum 1 and the fur brush 62 is moved to the collecting roller 63 by a potential difference between the fur brush 62 and the collecting roller 63 in the contact portion between the fur brush 62 and the collecting roller 63. That is, the potential of the collecting roller 63 is somewhat larger than the potential of the fur brush 62 in terms of an absolute value on a side opposite to the normal charge polarity. By this, at least a part of the toner collected by the fur brush 62 is electrostatically moved to the collecting roller 63. The toner moved to the collecting roller 63 in the contact portion between the fur brush 62 and the collecting roller 63 is scraped off the surface of the collecting roller 63 by the scraper member 64 in the contact portion between the collecting roller 63 and the scraper member 64. The toner scraped off the surface of the collecting roller 63 by the scraper member 64 drops by gravitation.

Further, the toner on the surface of the photosensitive drum 1 which was not collected by the fur brush 62 is scraped off the surface of the photosensitive drum 1 by the cleaning blade 61 and is accommodated in the housing 66.

The thus-collected toner in the housing 66 is fed by the feeding screw 65 disposed at a lower portion (bottom) of the housing 66 and is discharged to an outside of the housing 66.

Then, this toner is conveyed toward a collecting container (not shown) provided inside an apparatus main assembly or the like of the image forming apparatus 100 through a conveyance passage (not shown) provided inside the apparatus main assembly of the image forming apparatus 100.

Incidentally, in this embodiment, the application of the cleaning bias to the collecting roller 63 is started in synchronism with a timing when the charging device 2 starts drive (the charging process of the surface of the photosensitive drum 1) after the start of rotation of the photosensitive drum 1.

### <Cleaning Blade>

The cleaning blade 61 in this embodiment is made of an urethane rubber and is 340 mm in length with respect to a longitudinal direction, and is contacted to the photosensitive drum 1 at a predetermined pressure. From a viewpoint of a cleaning property, a preferred physical property of the cleaning blade 61 is as follows. Hardness (IRHD) may preferably be in a range of 65° or more and 85° or less. Further, rebound resilience coefficient in an environment of 25° C. may preferably be in a range of 15% or more and 60% or less. Further, an elongation at break in a tensile test is 300% or less. Further, Young's modulus may preferably be in a range of 50 kg/cm² or more and 200 kg/cm² or less. Further, 100%-modulus may preferable be in a range of 4.0 MPa or more and 9.0 MPa or less.

Incidentally, it is more preferable that the hardness (IRHD) is 70° or more and 80° or less, the elongation at break in a tensile test is 250% or less, and the rebound resilience coefficient at 25° C. is 15% or more and 35% or less.

The methods for measuring the above-described physical properties are as follows. The hardness (IRHD) of the produced cleaning blade 61 was measured in accordance with JIS K 6253 using a hardness tester manufactured by H.W. WALLACE. The 100% modulus of the produced cleaning blade 61 was measured in accordance with JIS K 6251 using a tensile tester (Unitron TS-3013) manufactured by Ueshima Seisakusho. Further, the elongation at break in the tensile test was measured in accordance with JIS K 6251 for the produced cleaning blade 61 using a tensile tester (Unitron TS-3013) manufactured by Ueshima Seisakusho.

The rebound resilience coefficient of the produced cleaning blade 61 was measured in an environment of 25° C. using a Lupke rebound resilience testing device manufactured by Ueshima Seisakusho, in accordance with JIS K 6255. Further, the Young's modulus of the produced cleaning blade 61 was measured in accordance with JIS K 6251 using a tensile tester (Unitron TS-3013) manufactured by Ueshima Seisakusho.

### <Fur Brush>

The fur brush 62 which is a rotating member is constituted by planting fibers on a rotating shaft. In this embodiment, the fur brush 62 is manufactured by winding a cloth material (base material) in which fibers are planted around a metallic rotating shaft having a diameter of 12.1 mm. As an example, the fiber (brush fiber) of the fur brush 62 is obtained by flocking a fiber in which 6 denier single fibers made of acrylic are bundled on the base material at a flocking density of 70 kF/inch² (flocking density per single fiber). Further, as an example, the overall outer diameter of the fur brush 62 (the outer diameter in the case where the brush fiber is not deformed by an external force) is 21.4 mm. Further, the length of the brush fiber obtained by subtracting the diameter of the core metal (12.1 mm) and the thickness of the base material (0.15 mm×2) from the outer diameter is 4.5 mm. Further, in this embodiment, as the brush fiber, an electroconductive fiber was used in which the electrical resistance of the fiber was adjusted by dispersing a certain amount of electroconductive particles such as carbon as an electroconductive agent in the base material of the fiber. From the viewpoint of cleaning property, preferred physical properties of the fur brush 62 are as follows. Tensile strength of the single fiber (herein also simply referred to as “tensile strength of the brush fiber”) in an environment of a temperature of 23° C. and humidity of 50% of the brush fiber may preferably be in the range of 50 cn/dtex or more and 80 cn/dtex or less. If the tensile strength of the brush fiber is less than 50 cn/dtex, the fiber may collapse at an early stage, and the toner may not be collected by the fur brush 62. Further, if the tensile strength of the brush fiber exceeds 80 cn/dtex, the surface of the photosensitive drum 1 may be damaged in the circumferential direction. Further, the electrical resistance of the fur brush 62 may preferably be in the range of 10 log (or more and 12 log Ω or less in an environment of a temperature of 23° C. and a humidity of 50%. If the electrical resistance is less than 10 log Ω, excessive current flows from the fur brush 62 to the photosensitive drum 1, which may cause positive memory. Further, if the electrical resistance exceeds 12 log Ω, a sufficient current may not flow through the fur brush 62 and the toner may not be collected by the fur brush 62.

The methods for measuring the above-described physical properties are as follows. The tensile strength of the single fiber in an environment of a temperature of 23° C. and a humidity of 50% of the brush fiber was measured in accordance with JIS L 1096:2010 Fabric testing for fabrics and knitted fabrics. Further, the electrical resistance of the fur brush 62 was measured as follows using a self-made device manufactured by Canon. That is, the fur brush 62 is brought into contact with the metallic roller under the condition of a penetration amount of 1 mm, and the fur brush 62 is rotated while a voltage of +400 V is applied to the fur brush 62. At this time, the electrical resistance of the fur brush 62 was measured by detecting the current flowing through the fur brush 62.

### <Collecting Roller>

In this embodiment, a solid SUS (stainless steel) metal roller having an outer diameter q 13 mm is used as the collecting roller 63.

### <Scraper Member>

Materials for the scraper member 64 include a nylon sheet material, a polyurethane rubber blade, and the like. In this embodiment, substantially the same as the cleaning blade 61 described above is used.

### 4. Pre-Cleaning Discharging Device

In this embodiment, the image forming apparatus 100 includes the pre-cleaning discharging device 16 as a charge-removing means for removing electric charges on the surface of the photosensitive drum 1 which passes through the primary transfer position Pd and then enters the brush cleaning position Pe. In this embodiment, the pre-cleaning discharging device 16 discharges the surface of the photosensitive drum 1 by irradiating the surface of the photosensitive drum 1 with a light. A position on the photosensitive drum 1 where discharge is performed (light is irradiated) by the pre-cleaning discharging device 16 with respect to the rotational direction of the photosensitive drum 1 is a pre-cleaning discharging position (pre-cleaning discharging portion) Pi. That is, with respect to the rotational direction of the photosensitive drum 1, the pre-cleaning discharging position Pi is located downstream of the primary transfer position Pd and upstream of the brush cleaning position Pe.

In this embodiment, the pre-cleaning discharging device 16 employs an LED as a discharging light source. However, the pre-cleaning discharging device 16 is not limited to this, and other discharging light sources such as a semiconductor laser may be used. Further, in this embodiment, the pre-cleaning discharging device 16 uses constant-current control as a method for controlling the power feed to the light source, and the current is set to 50 mA. The pre-cleaning discharging device 16 discharges the surface of the photosensitive drum 1 by irradiating light toward the surface of the photosensitive drum 1 (pre-cleaning exposure). Before the toner is electrostatically collected by the fur brush 62, the pre-cleaning discharging device 16 uniformly discharges the surface potential of the photosensitive drum 1 to about −50 V. Incidentally, as described above, the charging potential of the photosensitive drum 1 is about −500 V, and the exposure potential of the photosensitive drum 1 is about −200 V. Further, discharging refers to removing at least a part of the electric charges. Further, the pre-cleaning discharging device 16 only needs to perform the discharging process on at least the image forming area on the photosensitive drum 1 with respect to the direction of the rotational axis of the photosensitive drum 1. In this embodiment, the pre-cleaning discharging device 16 performs the discharging process on almost the entire area of the photosensitive drum 1 with respect to the direction of the rotational axis.

Here, in the case where a voltage of a polarity opposite to the normal charge polarity of the toner is applied to the fur brush 62 and the necessary current (cleaning current) flows between the fur brush 62 and the photosensitive drum 1, the toner is electrostatically collected from the photosensitive drum 1 to the fur brush 62. On the other hand, if the absolute value of the voltage applied to the fur brush 62 is too large, the charge polarity of the toner on the photosensitive drum 1 is reversed, and the toner may not be electrostatically collected from the photosensitive drum 1 to the fur brush 62. In the case where the pre-cleaning discharging device 16 is not provided, the toner may not be collected by the fur brush 62, for example, because the potential difference between the fur brush 62 and the photosensitive drum 1 is different between solid black image portions and solid white image portions (non-image portions), or the like. On the other hand, as in this embodiment, by providing the pre-cleaning discharging device 16 in the image forming apparatus 100, the potential difference between the fur brush 62 and the photosensitive drum 1 is appropriately maintained, making it easier for the fur brush 62 to appropriately collect the toner.

However, the present invention is not limited to this, and the image forming apparatus 100 may not include the pre-cleaning discharging device 16.

### 5. Suppression of Toner Fusion by Fur Brush and Setting of Cleaning Bias

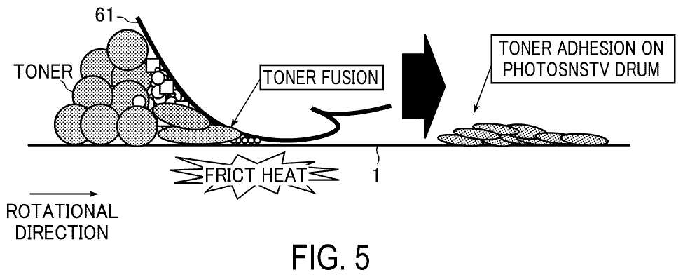

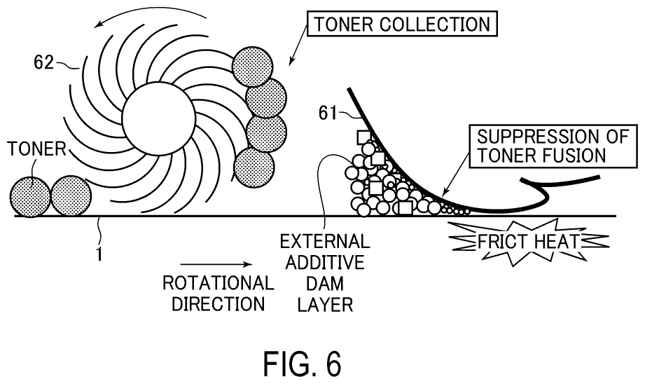

An effect of suppressing toner fusion by the fur brush 62 in this embodiment will be described. FIG. 5 is a schematic view for explaining the occurrence process of toner fusion. FIG. 6 is a schematic view for explaining the effect of suppressing toner fusion by the fur brush 62 in this embodiment.

As shown in FIG. 5, the cleaning blade 61 in contact with the photosensitive drum 1 rubs against the photosensitive drum 1, causing the temperature to rise in the vicinity of the contact portion (“blade nip”) between the cleaning blade 61 and the photosensitive drum 1. As a result, toner present in the vicinity of the blade nip melts and adheres to the photosensitive drum 1. Toner fusion is a phenomenon that occurs in this way.

Originally, in the vicinity of the blade nip, a deposit of external additive of the toner (“external additive dam layer”) (FIG. 6) is formed, suppressing the intrusion of toner into the vicinity of the blade nip. As a result, the temperature rise of the toner is suppressed, and toner fusion does not occur.

However, the small particle size toner, which has been developed in recent years to achieve high image quality, has high fluidity and easily destroys the external additive dam layer (FIG. 5). Further, as the process speed increases, the frictional heat generated by the rubbing between the cleaning blade 61 and the photosensitive drum 1 tends to increase, and toner fusion tends to occur.

Therefore, in this embodiment, as shown in FIG. 6, the fur brush 62 to which the cleaning bias is applied is provided upstream of the cleaning blade 61 with respect to the movement direction of the surface of the photosensitive drum 1. By this, the toner is collected by the fur brush 62 before it reaches the external additive dam layer. As a result, the external additive dam layer is stably maintained, thereby suppressing toner fusion. In this embodiment, the electroconductive fur brush 62 collects toner by applying a cleaning bias which is opposite in polarity to the normal charge polarity of the toner to the electroconductive fur brush 62. In this embodiment, for example, in the initial stage of use of the fur brush 62, a cleaning bias of +400 V is applied to the fur brush 62, so that the necessary current (cleaning current) flows between the fur brush 62 and the photosensitive drum 1, and the toner is collected by the fur brush 62.

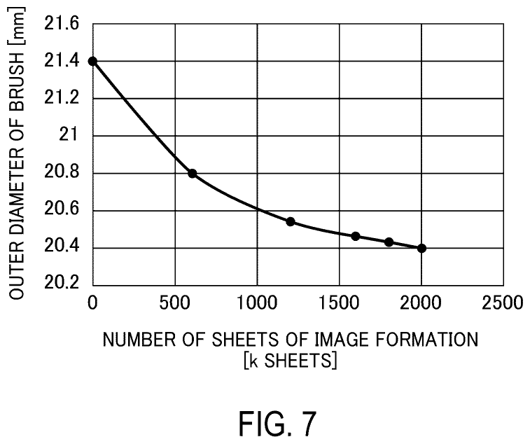

On the other hand, FIG. 7 is a graph showing the change in the outer diameter of the fur brush 62 as the accumulated usage amount of the fur brush 62 increases. As the accumulated usage amount of the fur brush 62 increases (after repeated use), the fiber tends to collapse (permanent deformation) due to the influence of the members (photosensitive drum 1, collecting roller 63) that have penetrated and come into contact with the fur brush 62, and the outer diameter of the fur brush 62 tends to become smaller. Therefore, the contact width between the photosensitive drum 1 and the fur brush 62 with respect to the movement direction of the surface of the photosensitive drum 1 becomes smaller, and the contact resistance (electrical resistance) between the photosensitive drum 1 and the fur brush 62 increases.

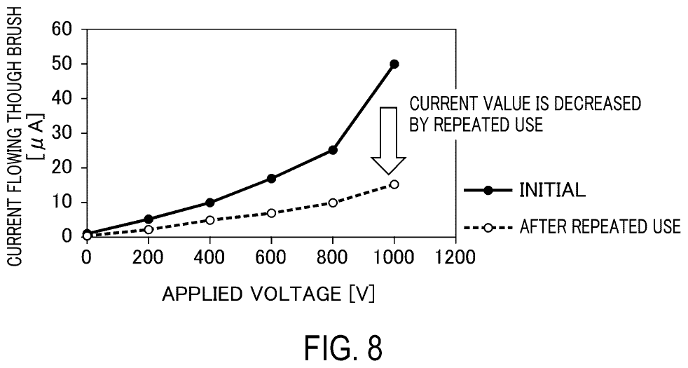

FIG. 8 is a graph showing the relationship between the voltage value of the cleaning bias and the value of the current flowing through the fur brush 62. FIG. 8 shows an example in which the surface potential of the photosensitive drum 1 entering the brush cleaning position Pe is about −50 V. As shown in FIG. 8, when the value of the cleaning bias applied to the fur brush 62 is fixed at a predetermined voltage value, the value of the current flowing through the fur brush 62 decreases as the accumulated usage amount of the fur brush 62 increases. As a result, the current (cleaning current) required for collecting the toner does not flow between the fur brush 62 and the photosensitive drum 1, and the toner cleaning property of the fur brush 62 decreases.

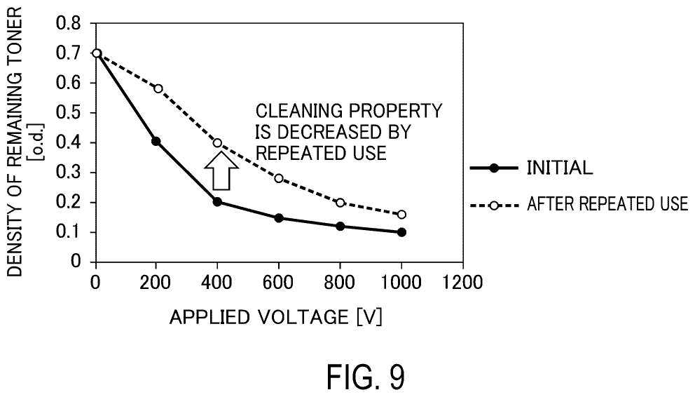

FIG. 9 is a graph showing the relationship between the voltage value of the cleaning bias and the toner cleaning property of the fur brush 62 when the fur brush 62 is in the initial stage of use and when the accumulated usage amount of the fur brush 62 has increased. In FIG. 9, the vertical axis indicates the amount of toner (optical density) remaining on the photosensitive drum 1 after passing through the brush cleaning position Pe (before reaching the blade cleaning position Pf). Further, FIG. 9 shows an example in which the surface potential of the photosensitive drum 1 entering the brush cleaning position Pe is about −50 V. As shown in FIG. 9, when the cleaning bias voltage of the same value is applied to the fur brush 62, the amount of toner that has slipped through the fur brush 62 is greater when the accumulated usage amount of the fur brush 62 has increased than when the fur brush 62 is in the initial stage of use. If the amount of toner that has slipped through the fur brush 62 increases, the toner that has slipped through may destroy the external additive dam layer in the vicinity of the blade nip. As a result, the toner approaches the vicinity of the blade nip whose temperature is rising, and the toner melts and adheres to the photosensitive drum 1, which may cause toner fusion.

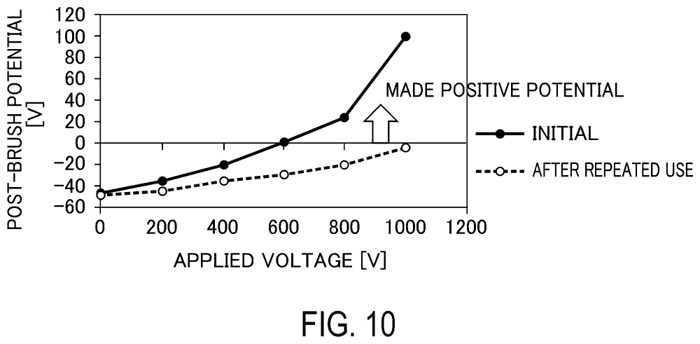

Further, FIG. 10 is a graph showing the relationship between the voltage value of the cleaning bias applied to the fur brush 62 and the potential (post-brush potential) of the photosensitive drum 1 after passing through the brush cleaning position Pe (before reaching the charging position Pa). FIG. 10 shows an example in which the surface potential of the photosensitive drum 1 entering the brush cleaning position Pe is about −50 V. As can be seen from FIG. 10, if the voltage value of the cleaning bias applied to the fur brush 62 is set high, assuming that the outer diameter of the fur brush 62 will become smaller, excessive current may flow between the fur brush 62 and the photosensitive drum 1 in the initial stage of use of the fur brush 62. This is because, in the initial stage of use of the fur brush 62, the outer diameter of the fur brush 62 does not change, and the contact resistance between the photosensitive drum 1 and the fur brush 62 is low. As a result, the surface potential of the photosensitive drum 1 after passing through the brush cleaning position Pe becomes positive (+0 V or higher), which is the polarity opposite to the normal charge polarity of the photosensitive drum 1, and an image defect called “positive memory” may occur on the photosensitive drum 1.

### 6. Control of Cleaning Bias in this Embodiment

In this embodiment, the cleaning bias is applied by constant-voltage control. In this embodiment, the voltage value (target voltage, set voltage) of the cleaning bias is determined so that the required current (cleaning current) can flow between the fur brush 62 and the photosensitive drum 1.

The required cleaning current is determined in advance by experiment or the like and stored in the ROM 203. In this embodiment, a cleaning bias setting operation (herein also simply referred to as “setting operation”), which is an operation for setting (determining, adjusting) the voltage value of the cleaning bias, is roughly performed as follows. The voltage value of the cleaning bias is determined based on the detecting result of the current when a plurality of test biases (test voltages) are applied to the fur brush 62. That is, the plurality of test biases are applied to the fur brush 62 by constant-voltage control. Further, the current flowing at that time is detected by the current detecting portion 21. This makes it possible to obtain the voltage-current characteristic (straight line or curve). In this embodiment, since the voltage-current characteristic obtained by applying the plurality of test biases to the fur brush 62 is a curve, three or more test biases (six in this embodiment) are applied to the fur brush 62. Then, based on the voltage-current characteristic, a voltage value for the required cleaning current is determined. This makes it possible to change the voltage value of the cleaning bias so that the required cleaning current flows in response to changes such as the contact resistance between the photosensitive drum 1 and the fur brush 62.

The CPU 201 controls the setting operation so as to be performed during non-image formation. The setting operation is typically performed in the pre-multiple rotation step (such as when the power is turned on in the morning). However, the present invention is not limited to this, and the setting operation can be performed at any timing during non-image formation. For example, the setting operation may be performed in the pre-rotation step for each job. Further, for example, the setting operation may be performed in the inter-sheet step for each predetermined number of sheets of image formation. Further, for example, the setting operation may be performed in the post-rotation step.

Here, during the setting operation, the plurality of test biases having different voltage values are applied to the fur brush 62. In this embodiment, the plurality of test biases are preset so that they can be applied within a range including a voltage value that provides the required cleaning current regardless of the accumulated usage amount of the fur brush 62. For example, in this embodiment, the required cleaning current is about 10 uA, and the voltage value of the cleaning bias at the initial stage of use of the fur brush 62 is about +400 V. In this case, for example, the plurality of test biases are applied, from the vicinity of 0 V to about +1000 V in increments of +200 V.

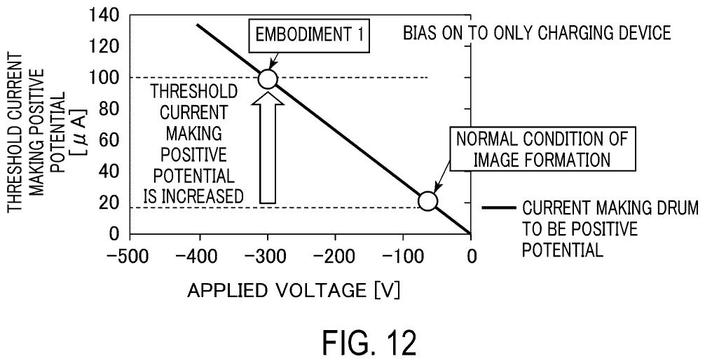

Therefore, if the conditions of the surface potential on the photosensitive drum 1 entering the brush cleaning position Pe when the plurality of test biases are applied to the fur brush 62 are the same as the conditions during normal image formation (herein also referred to as “normal image forming conditions”), the following may occur. That is, when the test biases are applied to the fur brush 62, the current flowing between the fur brush 62 and the photosensitive drum 1 becomes excessive, causing the surface potential of the photosensitive drum 1 to be on the plus side, which is the polarity opposite to the normal charge polarity, and positive memory may occur. This is because, when the surface potential of the photosensitive drum 1 entering the brush cleaning position Pe is in the vicinity of 0 V (approximately-50 V in this embodiment), a threshold value making positive potential described below is low, and when a large amount of current flows through the fur brush 62, a potential on the plus side is likely to be formed on the surface of the photosensitive drum 1 (the potential is likely to be reversed) (FIG. 12).

Therefore, in this embodiment, the surface potential of the photosensitive drum 1 entering the brush cleaning position Pe when the plurality of test biases are applied to the fur brush 62 during the setting operation is set to a value greater on the normal charge polarity side of the toner (the negative polarity side in this embodiment) than the surface potential of the photosensitive drum 1 entering the brush cleaning position Pe during image formation. Incidentally, the surface potential of the photosensitive drum 1 entering the brush cleaning position Pe can also be called the surface potential of the photosensitive drum 1 immediately before it reaches the brush cleaning position Pe after passing through the primary transfer position Pd. Here, the surface potential of the photosensitive drum 1 entering the brush cleaning position Pe, or the surface potential of the photosensitive drum 1 immediately before reaching the brush cleaning position Pe, is also simply referred to as the “pre-brush potential”.

In this embodiment, during image formation, a charging bias is applied to the charging device 2, the primary transfer bias is applied to the primary transfer roller 5, and the pre-cleaning exposure by the pre-cleaning discharging device 16 is turned on. Therefore, the pre-brush potential is about −50 V during image formation. On the other hand, in this embodiment, during the setting operation, a charging bias is applied to the charging device 2, but the primary transfer bias is not applied to the primary transfer roller 5, and the pre-cleaning exposure by the pre-cleaning discharging device 16 is not turned on. Therefore, the pre-brush potential when the plurality of test biases are applied to the fur brush 62 during the setting operation can be set to a value greater on the normal charge polarity side of the toner (negative polarity side in this embodiment) than the pre-brush potential during image formation. For example, when the plurality of test biases are applied to the fur brush 62 in the setting operation, the pre-brush potential is about −300 V. The pre-brush potential during the setting operation can be appropriately set in consideration of the accuracy of determining the voltage value of the cleaning bias that can obtain the required cleaning current, suppression of positive memory, and the like. Typically, a range including the potential of the non-image portion formed by the charging process during image formation, for example, about −200 V to −700 V, is suitable. This makes it possible to prevent the current flowing between the fur brush 62 and the photosensitive drum 1 from becoming excessive, thereby suppressing the occurrence of positive memory. This is because by increasing the pre-brush potential toward the normal charge polarity side of the toner and raising the threshold value making positive potential described later, a potential on the plus side is less likely to be formed on the surface of the photosensitive drum 1 (the potential is less likely to be reversed) even if a large amount of current flows through the fur brush 62 (FIG. 12).

In this embodiment, as a means for increasing the pre-brush potential to the negative polarity side compared to the normal image forming conditions, when the charging bias is turned on, the primary transfer bias is turned off (0 V) and the pre-cleaning exposure is turned off, but is not limited thereto. Examples of other means include the following. For example, instead of turning off the primary transfer bias, the primary transfer bias can be increased toward the normal charge polarity side of the toner with respect to the value during image formation. In this case, the primary transfer bias can be set to the same polarity (positive polarity) as that during image formation with a smaller absolute value, or can be set to the polarity opposite (negative polarity) than that during image formation. Further, for example, instead of turning off the pre-cleaning exposure, the light quantity (μJ/cm²) of the pre-cleaning exposure can be made smaller than that during image formation. In the case when either of the above means are used, the charging bias is turned on. Incidentally, although an example will be described later, the value of the charging bias may be the same as that during image formation, or may be different. Further, in a configuration in which the pre-cleaning discharging device 16 is not provided, the primary transfer bias may be turned off (or increased toward the normal charge polarity side of the toner with respect to the value during image formation).

Incidentally, in this embodiment, in order to suppress adhesion of toner or carrier to the photosensitive drum 1 during the setting operation or the like, the developing bias is applied to be turned on (typically the same developing bias as during image formation). Since the developing bias often does not affect the surface potential of the photosensitive drum 1, it may be turned on or off during the setting operation.

Further, the relationship of the pre-brush potential during the setting operation and the pre-brush potential during image formation described above needs to hold at least in the image forming area on the photosensitive drum 1 with respect to the direction of the rotational axis of the photosensitive drum 1. In this embodiment, the relationship between the pre-brush potential during the setting operation and the pre-brush potential during image formation described above holds over almost the entire area of the photosensitive drum 1 with respect to the direction of the rotational axis.

Further, since the present embodiment is configured to include a pre-cleaning discharging device 16, the pre-brush potential during image formation is substantially the same value in the image portion and non-image portion of the image forming area on the photosensitive drum 1 that has just passed through the primary transfer position Pd. However, in a configuration in which the pre-cleaning discharging device 16 is not provided, the pre-brush potential during image formation may differ between the image portion and the non-image portion of the image forming area on the photosensitive drum 1 that has just passed through the primary transfer position Pd. Therefore, more specifically, the pre-brush potential during image formation is represented by the surface potential of the non-image portion of the image forming area on the photosensitive drum 1 that has just passed through the primary transfer position Pd.

### 7. Control Procedure

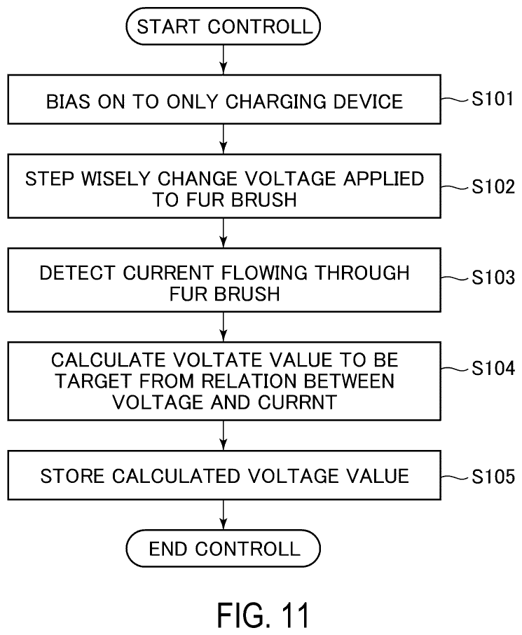

Next, an example of a procedure in the setting operation in this embodiment will be described. FIG. 11 is a flow chart showing an outline of the procedure.

First, while the photosensitive drum 1 is rotating, the CPU 201 controls so as to charge the photosensitive drum 1 by applying a charging bias without applying a primary transfer bias or without turning on the pre-cleaning exposure light (S101). In this embodiment, at this time, the intermediary transfer belt 7 is rotating in contact with the photosensitive drum 1, the developing sleeve 41 is also rotating, and the same developing bias as during image formation is applied to the developing sleeve 41. Further, at this time, for example, a voltage is applied to the discharge electrode 2a so that a current of −1000 ρA flows through the discharge electrode 2a, and a voltage of −400 V is applied to the grid electrode 2b. This uniformly charges the surface of the rotating photosensitive drum 1 to a surface potential of about −300 V. As a result, the pre-brush potential becomes approximately −300 V.

FIG. 12 is a graph showing the relationship between the pre-brush potential and the threshold value of the cleaning current (herein also referred to as “threshold value making positive potential”) at which the surface potential of the photosensitive drum 1 becomes positive. As described above, during normal image formation, the charging bias is applied, the primary transfer bias is applied, the pre-cleaning exposure is turned on, and the pre-brush potential is about −50 V. On the other hand, as described above, during the setting operation, the pre-brush potential is approximately −300 V. As shown in FIG. 12, the threshold value making positive potential can be increased by making the pre-brush potential during the setting operation larger toward the normal charge polarity side of the toner than the pre-brush potential during image formation. This makes it possible to suppress the occurrence of positive memory.

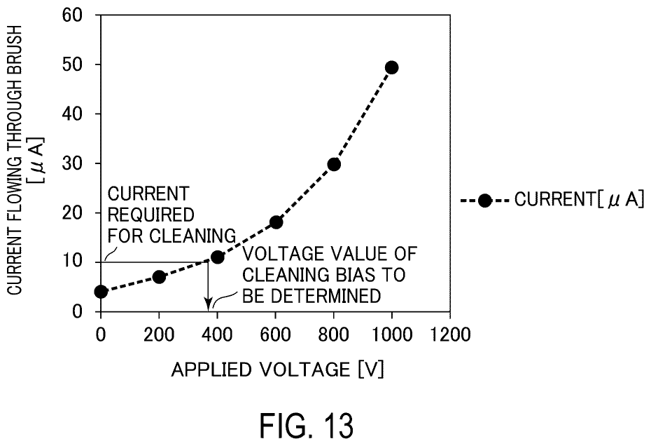

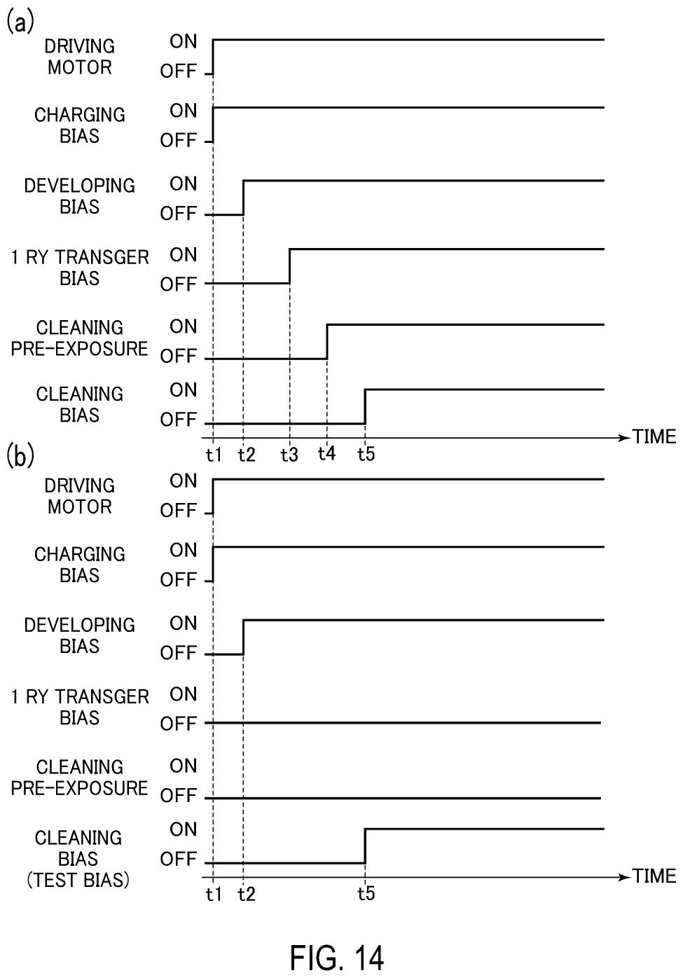

Next, the CPU 201 controls the current detecting portion 21 to detect the current flowing through the fur brush 62 (S103) while changing stepwise the test biases applied to the fur brush 62 (for example, in increments of 200 V) (S102). Next, the CPU 201 determines a voltage value of the cleaning bias of the cleaning current required during image formation that can flow between between the fur brush 62 and the photosensitive drum 1 based on the obtained relationship between the voltage value and the current value (voltage-current characteristic) (S104). Here, the CPU 201 calculates a voltage value at which a predetermined current value (the cleaning current required) is obtained by interpolating the detection data. Further, the CPU 201 adjusts the potential difference between the pre-brush potential during the setting operation and the pre-brush potential during image formation, and determines the voltage value of the cleaning bias. That is, the voltage value of the cleaning bias during image formation is determined by adding the difference (−250 V) between the pre-brush potential during the setting operation (−300 V) and the pre-brush potential during image formation (−50 V) to the voltage value obtained based on the detected data. FIG. 13 is a graph showing a method for determining the voltage value of the cleaning bias based on the detecting result obtained by applying the plurality of test biases. FIG. 13 shows the voltage-current characteristic (voltage-current characteristic obtained by shifting the obtained detecting result by the difference in the pre-brush potential) when the pre-brush potential is −50 V. The CPU 201 stores the determined voltage value of the cleaning bias in the RAM 202 (S105). Then, during image formation, the CPU 201 controls so as to apply the cleaning bias, which is constant-voltage controlled at the voltage value determined as described above, to the fur brush 62.

Part (a) of FIG. 14 is a timing chart showing the operation of each portion during normal image formation, and part (b) of FIG. 14 is a timing chart showing the operation of each portion during the setting operation. Part (a) and part (b) of FIG. 14 show an example in which the operation starts from a state in which the rotation of the photosensitive drum 1 is stopped. As shown in part (a) of FIG. 14, during image formation, application of the charging bias starts almost simultaneously with the start of rotation of the photosensitive drum 1 (t1). Thereafter, for example, application of the developing bias, application of the primary transfer bias, lighting of the pre-cleaning exposure, and application of the cleaning bias are started in accordance with the timing when the charged area on the photosensitive drum 1 reaches the developing position Pc, the primary transfer position Pd, the pre-cleaning discharging position Pi, and the brush cleaning position Pe (t2 to t5). Incidentally, application of the primary transfer bias, lighting of the pre-cleaning exposure, and application of the cleaning bias may be started, for example, almost simultaneously with the start of rotation of the photosensitive drum 1, or almost simultaneously with the start of application of the charging bias. On the other hand, as shown in part (b) of FIG. 14, during the setting operation, application of the charging bias starts almost simultaneously with the start of rotation of the photosensitive drum 1 (t1). Thereafter, application of the developing bias is started in accordance with the timing at which the charged area on the photosensitive drum 1 reaches the developing position Pc (t2). Further, thereafter, after the timing when the charged area on the photosensitive drum 1 reaches the brush cleaning position Pe, the test biases are applied (t5). Further, during the setting operation, the application of the primary transfer bias and the lighting of the pre-cleaning exposure are not performed.

Incidentally, the voltage value of the cleaning bias for the fur brush 62 in the initial stage of use may be a predetermined value that has been preset. In this case, the setting operation can be performed when the accumulated usage amount of the fur brush 62 reaches a predetermined usage amount. For example, the image forming apparatus 100 may be provided with a counter (parts counter) 205 (FIG. 3) configured to include a memory portion that memorizes an index value (usage history information) correlated with the accumulated usage amount amount of the fur brush 62. As this index value, any index value can be used as long as it is correlated with the accumulated usage amount of the fur brush 62. For example, this index value may be the number of sheets of image formation, the rotation time or the number of rotations (rotation distance) of the photosensitive drum 1 or the fur brush 62, or the like. If the fur brush 32 is replaceable, this index value is reset to an initial value (for example, 0) when the fur brush 62 is replaced, and the value after replacement is counted anew. As an example, the counter 205 can accumulate and memorize the number of sheets of image formation each time an image is formed on one side of the recording material P (the counter 205 may also be configured to accumulate the number of sheets converted for a recording material of a predetermined size). Then, for example, when the count value of the counter 205 during execution of a job exceeds a predetermined count value, the CPU 201 can control so that the setting operation is performed during the post-rotation step after image formation for that job is completed.

However, as mentioned above, the setting operation can be performed at any timing during non-image formation, such as during the pre-multiple rotation step after the image forming apparatus 100 is turned on, during the pre-rotation step at the start of a job, during the inter-sheet step, or during the post-rotation step. Further, the execution frequency of the setting operation can also be set appropriately depending on the configuration of the fur brush 62, or the like. For example, the setting operation may be performed every time the image forming apparatus 100 is turned on or a job is started, or may be performed when the count value of a necessity determination counter for determining whether or not the setting operation needs to be performed exceeds a predetermined threshold value. This necessity determination counter, for example, may count any event suitable for setting the execution frequency of the setting operation, such as the elapsed time since the last time the setting operation was performed, the number of jobs that have been executed, or the number of times the power has been turned on.

### 8. Test Results

The results of tests to confirm the effect of this embodiment will be described. Image formation was performed on 2 million sheets in a high humidity and high temperature environment (30° C./80%), and the occurrence of image defects due to toner fusion on the photosensitive drum 1 and the occurrence of image defects due to positive memory were confirmed. As toner fusion on the photosensitive drum 1 progresses, white spots where the image is partially missing occurs on the recording material P on which a solid black image has been formed. Among the 2 million sheets, if a white spot having a size of 2 mm or more was generated on the recording material P on which a solid black image was formed, it was judged as defective (x), and if no white spot was generated, it was judged as good (o). Further, as positive memory progresses, density unevenness occurs in halftone images. Among the 2 million sheets, if the density difference on the recording material P on which the halftone image was formed was outside the allowable range, it was judged as defective (x), and if the density difference was within the allowable range, it was judged as good (o). Further, if either of the above-described image defects occurred, the test was stopped. The tests were conducted for a case in which the setting operation was periodically performed according to this embodiment to adjust the voltage value of the cleaning bias (in this example, performed once a day), and for Comparative Examples 1 and 2 in which the voltage value of the cleaning bias was fixed. In Comparative Example 1, the voltage value of the cleaning bias was fixed at +400 V, and in Comparative Example 2, the voltage value of the cleaning bias was fixed at +800 V. The image forming apparatuses in Comparative Examples 1 and 2 have substantially the same configuration as the image forming apparatus in this embodiment, except for the above-described points. The results are shown in Table 1.

TABLE 1

| | | | Com- | Com- |
|---|---|---|---|---|
| | | | parative | parative |
| | | Embodiment 1 | Example 1 | Example 2 |
| Verified | Applied | Variable by | Fixed | Fixed |
| conditions | voltage value | setting | 400 V | 800 V |
| | | operation | | |
| | | 400-1000 V | | |
| Results | Image defect | ○2 million | ×1 million | ○200,000 |
| | due to toner | sheets | sheets | sheets |
| | fusion | | | |
| | Image defect | ○2 million | ○1 million | ×100,000 |
| | due to positive | sheets | sheets | sheets |
| | memory | | | |

In Comparative Example 1, an image defect occurred due to toner fusion after image formation was performed on 1 million sheets. This is considered to be caused by a decrease in the cleaning property of the fur brush 62. Further, in Comparative Example 2, an image defect occurred due to positive memory after image formation was performed on 200,000 sheets. This is considered to be caused by excessive current flowing through the photosensitive drum 1. On the other hand, in this embodiment, neither image defects due to toner fusion nor image defects due to positive memory occurred during image formation on 2 million sheets.

Incidentally, in the present embodiment, in the setting operation, the plurality of test biases were applied under constant-voltage control, but the plurality of test biases may be applied under constant-current control. At least one of the plurality of test biases may be applied under constant-voltage control, and at least one of the plurality of test biases may be applied under constant-current control. If the test biases are applied under constant-current control, the value of the voltage generated when the test biases are applied is detected by a voltage detecting portion (voltage detecting circuit) as a voltage detecting means. That is, the cleaning bias can be determined based on the detecting result of the current or voltage when the plurality of test biases (test voltages or test currents) are applied to the fur brush 62. It is only necessary to determine the voltage-current characteristic (straight line or curve) according to the electrical resistance of the fur brush 62 (more specifically, the contact resistance between the photosensitive drum 1 and the fur brush 62). Here, the constant-current control refers to control that adjusts the output by the power source so that the current supplied to the supply target is substantially constant at a target current. Further, the constant-voltage control is a control that adjusts the output by the power source so that the voltage applied to the application target is substantially constant at a target voltage.

Further, in this embodiment, the cleaning bias is subjected to be the constant-voltage control but is not limited to this, and the cleaning bias may be subject to the constant-current control. In this case, the setting operation can determine, for example, an initial voltage value when the cleaning bias is applied.

### 9. Effects

Thus, in this embodiment, the image forming apparatus 100 comprises: the rotatable photosensitive member (photosensitive drum) 1; the charging device 2 configured to charge the surface of the photosensitive member 1 at the charging position Pa; the charge bias applying portion (charging power source) E1 configured to apply the charging bias, for charging the surface of the photosensitive member 1, to the charging device 2; the developing device 4 configured to supply the toner to the surface of the photosensitive member 1; the transfer device (primary transfer roller) 5 configured to transfer the toner to the transferred member (intermediary transfer belt) 7 from the surface of the photosensitive member 1 at the transfer position (primary transfer position) Pd; the transfer bias applying portion (primary transfer power source) E3 configured to apply the transfer bias, for transferring the toner to the transferred member 7 from the photosensitive member 1, to the transfer device 5; the cleaning blade 61 in contact with the surface of the photosensitive member 1 at the blade cleaning position Pf downstream of the transfer position Pd and upstream of the charging position Pa with respect to the rotational direction of the photosensitive member 1 and configured to remove the toner from the surface of the photosensitive member 1; the rotatable roller-like brush (fur brush) 62 in contact with the surface of the photosensitive member 1 at the brush cleaning position Pe downstream of the transfer position Pd and upstream of the blade cleaning position Pf with respect to the rotational direction of the photosensitive member 1 and configured to remove the toner from the surface of the photosensitive member 1; the cleaning bias applying portion (cleaning power source) E5 configured to apply the cleaning bias of the polarity opposite to the normal charge polarity to the brush 62; the detecting portion (in this embodiment, the current detecting portion) 21 configured to detect the current flowing through the brush 62 or the voltage applied to the brush 62; and the control portion (CPU) 201, during non-image formation, configured to cause the cleaning bias applying portion E5 to apply the plurality of test biases to the brush 62 and to perform the setting operation in which the voltage to be applied by the cleaning bias applying portion E5 is set based on the detecting result by the detecting portion 21 when the plurality of test biases are applied. Further, in this embodiment, if the surface potential of the photosensitive drum 1 immediately before it first reaches the brush cleaning position Pe after passing through the primary transfer position Pd is the pre-brush potential, the control portion 201 controls the pre-brush potential in the area on the photosensitive member, which has passed through the cleaning position Pe while the plurality of test biases are applied to the brush 62 during the setting operation, to be larger on the normal charge polarity side of the toner than the pre-brush potential in the non-image portion of the photosensitive member during image formation.

Further, in this embodiment, the control portion 201 controls so as to apply the plurality of test biases to the brush when the area on the photosensitive member, which has passed through the charging position Pa while the charging bias is applied to the charging device 2 and which has passed through the transfer position Pd while the transfer bias is not applied to the transfer device 5, is passing through the brush cleaning position Pe. In particular, in this embodiment, the image forming apparatus 100 comprises the pre-cleaning discharging device 16 configured to perform the discharging process to remove at least a part of electric charges on the surface of the photosensitive member 1 at the pre-cleaning discharging position Pi downstream of the transfer position Pd and upstream of the brush cleaning position Pe with respect to the rotational direction of the photosensitive member 1, and the control portion 201 controls so as to apply the plurality of test biases to the brush 62 when the area on the photosensitive member 1, which has passed through the charging position Pa while the charging bias is applied to the charging device 2, which has passed through the transfer position Pd while the transfer bias is not applied to the transfer device 5, and which has passed through the pre-cleaning discharging position Pi while the discharging process is not performed by the pre-cleaning discharging device, is passing through the brush cleaning position Pe. In this embodiment, the pre-cleaning discharging device 16 performs the discharging process by irradiating the surface of the photosensitive member 1 with a light.

As described above, according to this embodiment, it is possible to apply an appropriate cleaning bias to the fur brush 62 regardless of the accumulated usage amount of the fur brush 62 while suppressing the occurrence of positive memory on the photosensitive drum 1. By this, the toner cleaning property of the fur brush 62 can be maintained stably, and the occurrence of toner fusion on the photosensitive drum 1 can be suppressed for a long period of time.

### Embodiment 2

Next, another embodiment of the present invention will be described. The basic configuration and operation of the image forming apparatus of this embodiment are the same as those of the image forming apparatus of embodiment 1. Therefore, in the image forming apparatus of this embodiment, elements having the same or corresponding functions or configurations as those in the image forming apparatus of embodiment 1 are designated by the same reference numerals as those of embodiment 1, and detailed explanations thereof are omitted.

### 1. Overview of this Embodiment

In this embodiment, the pre-brush potential (charging bias value) during the setting operation is changed based on the accumulated usage amount (usage history information) of the fur brush 62.

As the accumulated usage amount of the fur brush 62 increases, the outer diameter of the fur brush 62 becomes smaller, which increases the contact resistance between the photosensitive drum 1 and the fur brush 62, thereby reducing the value of the current flowing between the fur brush 62 and the photosensitive drum 1. Therefore, during the setting operation, the pre-brush potential (charging bias value) is increased toward the normal charge polarity side of the toner, and the value of the current flowing between the fur brush 62 and the photosensitive drum 1 is increased. This makes it possible to improve the accuracy of determining the voltage value of the cleaning bias that provides the required cleaning current while suppressing the occurrence of positive memory in the photosensitive drum 1. Further, the voltage value of at least one of the plurality of test biases in the setting operation may be changed based on the accumulated usage amount of the fur brush 62. For example, as the accumulated usage amount of the fur brush 62 increases, the absolute value of the voltage value of at least one of the plurality of test biases can be increased. Typically, the absolute value of at least the largest test bias among the plurality of test biases can be increased as the accumulated usage amount of the fur brush 62 increases so as to include the voltage value at which the required cleaning current is obtained.

### 2. Control Procedure

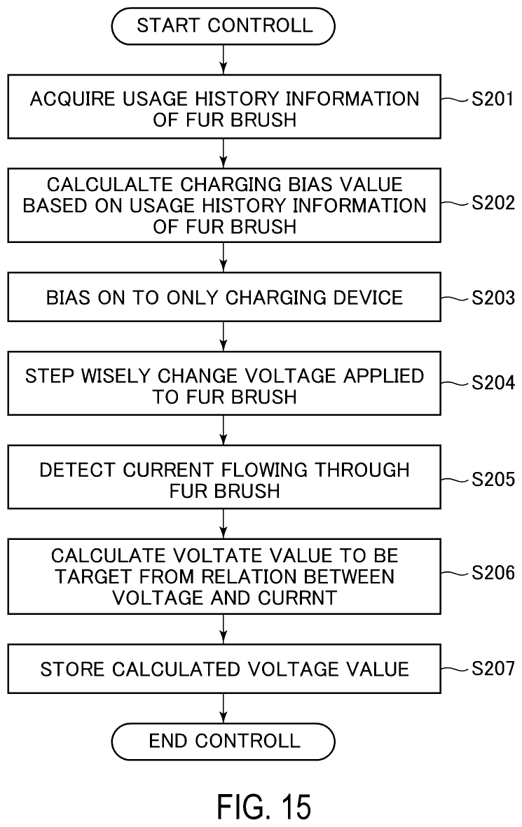

Next, an example of the procedure of the setting operation in this embodiment will be described. FIG. 15 is a flow chart showing an outline of the procedure.

First, the CPU 201 obtains (acquires) the usage history information of the fur brush 62 from the counter 205 (S201). Here, the usage history information of the fur brush 62 is the number of sheets of image formation since the fur brush 62 was replaced. Next, the CPU 201 determines the value of the charging bias based on the usage history information of the fur brush 62 (S202). In this embodiment, as the accumulated usage amount of the fur brush 62 increases, the absolute value of the charging bias voltage value (voltage applied to a grid 2b) is increased. This increases the pre-brush potential toward the normal charge polarity side of the toner as the accumulated usage amount of the fur brush 62 increases. In this embodiment, information indicating the relationship between the accumulated usage amount (usage history information) of the fur brush 62 and the voltage value of the charging bias is preset and stored in the ROM 203. The CPU 201 reads from the ROM 203 the charging bias setting corresponding to the acquired usage history information, and uses it to control the charging power source E1 (grid power source portion E1b).

Next, while the photosensitive drum 1 is rotating, the CPU 201 controls the photosensitive drum 1 to be charged by applying the charging bias determined as described above without applying the primary transfer bias or turning on the pre-cleaning exposure (S203). In this embodiment, at this time, the intermediary transfer belt 7 is rotating in contact with the photosensitive drum 1, the developing sleeve 41 is also rotating, and the same developing bias as during image formation is applied to the developing sleeve 41. Further, at this time, for example, when the fur brush 62 is in the initial stage of use (number of sheets of image formation is 0 to 1 million sheets), a voltage is applied to the discharge electrode 2a so that a current of −1000 uA flows, and a voltage of −400 V is applied to the grid electrode 2b. By this, the surface of the rotating photosensitive drum 1 is uniformly charged to a surface potential of about −300 V. As a result, the pre-brush potential becomes approximately −300 V. On the other hand, when the accumulated usage amount of the fur brush 62 increases (number of sheets of image formation is over 1 million sheets), a voltage is applied to the discharge electrode 2a so that a current of −1000 uA flows, and a voltage of −700 V is applied to the grid electrode 2b. By this, the surface of the rotating photosensitive drum 1 is uniformly charged to a surface potential of about −600 V. As a result, the pre-brush potential becomes approximately −600 V.

Next, the CPU 201 controls the current detecting portion 21 to detect the current flowing through the fur brush 62 (S205) while stepwise changing the test biases (for example, by 200 V) applied to the fur brush 62 (S204). Further, at this time, the CPU 201 may control so as to increase the absolute value of at least one of the voltage values of the plurality of test biases as the accumulated usage amount of the fur brush 62 increases. For example, the step width of the plurality of test biases can be increased. Further, alternatively or additionally, the number of the plurality of test biases can be increased. Next, the CPU 201 determines the voltage value of the cleaning bias that can pass the cleaning current required during image formation between the fur brush 62 and the photosensitive drum 1 based on the obtained relationship between the voltage value and the current value (voltage-current characteristic) (S206). The method for determining the voltage value of this cleaning bias is the same as in embodiment 1. However, in this embodiment, the voltage value of the cleaning bias is determined by adjusting the potential difference between the pre-brush potential during the setting operation and the pre-brush potential during image formation in accordance with the pre-brush potential during the setting operation that is changed as described above. The CPU 201 memorizes the determined voltage value of the cleaning bias in the RAM 202 (S207). Further, during image formation, the CPU 201 controls so that the cleaning bias, which is constant-voltage controlled at the voltage value determined as described above, is applied to the fur brush 62.

Thus, in this embodiment, the image forming apparatus 100 comprises the memory portion (counter) 205 configured to memorize usage history information correlating with the accumulated usage amount of the brush 62, wherein the control portion 201 controls to change the pre-brush potential on the area of the photosensitive member, just before passing through the brush cleaning position Pe while the plurality of test biases are applied to the brush 62 during the setting operation, based on the above-described usage history information. In this embodiment, the control portion 201 controls so that the pre-brush potential of the area on the photosensitive member, just before passing through the brush cleaning position Pe while the plurality of test biases are applied to the brush 62 during the setting operation, becomes a first surface potential, in a case in which the accumulated usage amount of the brush 62 indicated by the usage history information is a first usage amount, and controls so that the pre-brush potential of the area on the photosensitive member, just before passing through the brush cleaning position Pe while the plurality of test biases are applied to the brush during the setting operation, becomes a second surface potential larger on the normal charge polarity side than the first surface potential, in a case in which the accumulated usage amount of the brush 62 indicated by the usage history information is a second usage amount larger than the first usage amount. Further, the control portion 201 controls so as to change at least one of the plurality of test biases based on the above-described usage history information. For example, when the accumulated usage amount of the brush 62 indicated by the above-described usage history information is a first usage amount and a second usage amount larger than the first usage amount, the control portion 201 controls so that the largest test bias in absolute value of the plurality of test biases in a case in which the accumulated usage amount is the second usage amount becomes larger in absolute value than the largest test bias in absolute value of the plurality of test biases in a case in which the accumulated usage amount is the first usage amount. Further, the control portion 201 controls so that, in a case in which the accumulated usage amount of the brush 62 indicated by the above-described usage history information is a first amount, a difference between the plurality of test biases successively applied to the brush 62 becomes a first difference, and controls so that, in a case in which the accumulated usage amount of the brush indicated by the above-described usage history information is a second amount larger than the first amount, a difference between the plurality of test biases successively applied to the brush 62 becomes a second difference larger than the first difference. Further, the control portion 201 controls so that, in a case in which the accumulated usage amount of the brush 62 indicated by the above-described usage history information is a first usage amount, a number of the plurality of test biases becomes a first number, and controls so that, in a case in which the accumulated usage amount of the brush 62 indicated by the above-described usage history information is a second usage amount larger than the first usage amount, a number of the plurality of test biases becomes a second number larger than the first number.

As described above, according to this embodiment, by changing the pre-brush potential in accordance with the usage history information of the fur brush 62 during the setting operation, it is possible to improve the accuracy of determining the voltage value of the cleaning bias while suppressing the occurrence of positive memory.

### OTHER

Although the present invention has been described above with reference to specific embodiments, the present invention is not limited to the above-described embodiments.

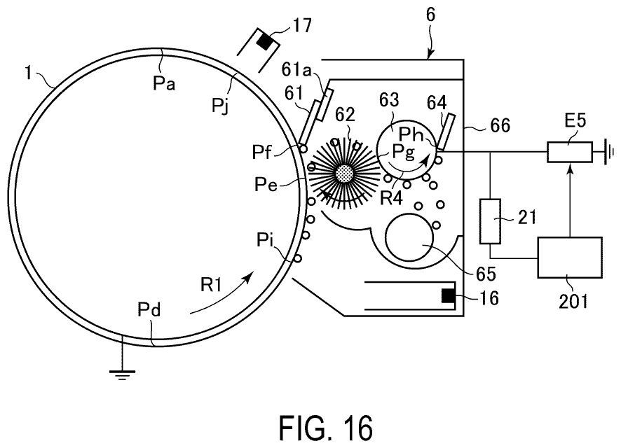

In the above-described embodiments, the image forming apparatus did not include a means for discharging the surface of the photosensitive member after it passes through the pre-cleaning discharging position and before it reaches the charging position, but the image forming apparatus may include such a means. FIG. 16 is a schematic sectional view of the periphery of a cleaning device in another example of an image forming apparatus. In the image forming apparatus shown in FIG. 16, elements having the same or corresponding functions or configurations as those in the image forming apparatus of the above-described embodiments will be described with the same reference numerals. The image forming apparatus 100 shown in FIG. 16 includes a pre-charging discharging device 17 as a charge-removing means that removes electric charges on the surface of the photosensitive drum 1 entering the charging position Pa after passing through the blade cleaning position Pf. In this example, the pre-charging discharging device 17 irradiates the surface of the photosensitive drum 1 with light to remove electric charges therefrom. The position on the photosensitive drum 1 where the pre-charging discharging device 17 performs discharging (irradiates light) with respect to the rotational direction of the photosensitive drum 1 is a pre-charging discharging position (pre-charging discharging portion) Pj. That is, with respect to the rotational direction of the photosensitive drum 1, the pre-charging discharging position Pj is located downstream of the blade cleaning position Pf and upstream of the charging position Pa. As the pre-charging discharging device 17, one having the same configuration as the pre-cleaning discharging device 16 can be used. By providing the pre-charging discharging device 17 in the image forming apparatus 100, the surface potential of the photosensitive drum 1 entering the charging position Pa can be uniformly discharged, making it easier to perform stable and uniform charging at the charging position Pa. Incidentally, since it is difficult for the pre-charging discharging device 17 to level the surface potential of the photosensitive drum 1 which has been made a positive potential, it is desirable to suppress positive memory even in a configuration in which the pre-charging discharging device 17 is provided. In the image forming apparatus 100 shown in FIG. 16, during image formation and during the setting operation, the pre-charging discharging device 17 performs the discharging process on the surface of the photosensitive drum 1. Thus, the image forming apparatus 100 may include a pre-charging discharging device 17 that performs the discharging process to remove at least a part of the charge on the surface of the photosensitive member at the pre-charging discharging position Pj which is downstream of the blade cleaning position Pf and upstream of the charging position Pa with respect to the rotational direction of the photosensitive member 1. The pre-charging discharging device 17 may perform the discharging process by irradiating the surface of the photosensitive member 1 with light.

Further, in the above-described embodiments, the rotatable roller-like brush is rotationally driven so as to move in the same direction as the photosensitive member in the contact portion with the photosensitive member, but the present invention is not limited thereto. For example, a constitution in which the rotatable roller-like brush is rotationally driven so as to move in a direction opposite to the rotational direction of the photosensitive drum 1 in the contact portion with the photosensitive member and is rotated with a speed difference from the photosensitive member may also be employed. Similarly, in the above-described embodiments, the collecting member is rotationally driven so as to move in the same direction as the brush in the contact portion with the brush, but may also be rotationally driven so as to move in the opposite direction to the rotational direction of the brush.

Further, in the above-described embodiments, the constitution in which the electric charges are removed by light as the charge-removing means was used, but the present invention is not limited thereto. For example, a constitution in which the electric charges are removed by AC discharge with a charger or by causing the electric charges to escape into an electroconductive member contacting the photosensitive member may also be employed.

Further, the present invention can also be applied to a configuration in which the normal charge polarity of the photosensitive member is positive. For example, in this case, the normal charge polarity of the toner can be positive. Even when the normal charge polarity of the photosensitive member is positive, the application of a bias to the fur brush can cause the surface potential of the photosensitive member to become opposite in polarity to the normal charge polarity, resulting in problems similar to those in the above-described embodiments. Also in this case, the configuration may be such that the test voltage may be applied to the brush when the drum area in which the drum potential when determining the cleaning voltage is increased toward the normal charge polarity side of the drum passes through the cleaning brush position.

Further, in addition to or in lieu of turning off the primary transfer bias in the above-described embodiments, the intermediary transfer belt may be separated from the photosensitive drum.

Further, in the above-described embodiments, the image forming apparatus was the image forming apparatus employing the intermediary transfer type, but the present invention is also applicable to an image forming apparatus of a direct transfer type. As is well known by the person ordinarily skilled in the art, a tandem-type image forming apparatus employing the direct transfer type includes a recording material carrying member constituted by an endless belt or the like, in place of the intermediary transfer member in the above-described embodiments. Further, the toner images formed on the photosensitive members of the image forming portions are directly transferred onto the recording material carried and conveyed by the recording material carrying member, similarly as in the primary transfer in the image forming apparatus of the intermediary transfer type. Also, in such an image forming apparatus, by applying the present invention in conformity to the above described embodiments, an effect similar to the effects of the above-described embodiments can be obtained.

Further, in the above-described embodiments, the number of the image forming portions was four, but the present invention is not limited thereto. The present invention is also applicable to an image forming apparatus including five or more (for example, six) image forming portions. Further, in the above-described embodiments, the image forming apparatus has the constitution in which the toners use the four colors of Y, M, C and K, but the present invention is not limited to such embodiments. The image forming apparatus may also have a constitution in which transparent toner, metallic color toner, or the like may be used in addition to or in place of either one of Y, M, C and K.

Further, in the above-described embodiments, the image forming apparatus was the color image forming apparatus including the plurality of image forming portions, but the present invention is also applicable to a monochromatic (single color) image forming apparatus including only one image forming portion, for example.

According to the present invention, it is possible to apply an appropriate bias to the fur brush regardless of the accumulated usage amount of the fur brush, while suppressing charging failure of the photosensitive member caused by the application of a bias to the fur brush.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075011, filed on May 4, 2024, which is hereby incorporated by reference herein in its entirety.

What is claimed is:

1. An image forming apparatus comprising:
a rotatable photosensitive member;
a charging device configured to charge a surface of the photosensitive member at a charging position;
a charge bias applying portion configured to apply a charging bias, for charging the surface of the photosensitive member, to the charging device;
a transfer device configured to transfer toner to a transferred member from the surface of the photosensitive member at a transfer position;
a transfer bias applying portion configured to apply a transfer bias, for transferring the toner to the transferred member from the photosensitive member, to the transfer device;
a cleaning blade in contact with the surface of the photosensitive member at a blade cleaning position downstream of the transfer position and upstream of the charging position with respect to a rotational direction of the photosensitive member and configured to remove the toner from the surface of the photosensitive member;
a rotatable brush in contact with the surface of the photosensitive member at a brush cleaning position downstream of the transfer position and upstream of the blade cleaning position with respect to the rotational direction of the photosensitive member and configured to remove the toner from the surface of the photosensitive member;
a cleaning bias applying portion configured to apply a cleaning bias to the brush;
a detecting portion configured to detect a current flowing through the brush or a voltage applied to the brush; and
a control portion, during non-image formation, configured to cause the cleaning bias applying portion to apply a plurality of test biases to the brush and to perform a setting operation in which a voltage to be applied by the cleaning bias applying portion is set based on a detecting result by the detecting portion when the plurality of test biases are applied.

2. The image forming apparatus according to claim 1, wherein the control portion, during cleaning, is configured to perform constant voltage control so that the voltage to be applied by the cleaning bias applying portion becomes a target voltage and, in performing the setting operation, to determine the target voltage based on the detecting result of the detecting portion when the plurality of test biases are applied.

3. The image forming apparatus according to claim 1, wherein the charging device is configured to charge the surface of the photosensitive member to the same polarity of a normal charge polarity of the toner,
wherein the cleaning bias applying portion is configured to apply the cleaning bias having a polarity opposite to the normal charge polarity of the toner to the brush during cleaning, and
wherein the control portion controls so as to apply the plurality of test biases to the brush when an area on the photosensitive member, which has passed through the charging position while the charging bias is applied to the charging device and which has passed through the transfer position while the transfer bias is not applied to the transfer device, is passing through the brush cleaning position.

4. The image forming apparatus according to claim 1, wherein the charging device is configured to charge the surface of the photosensitive member to the same polarity of a normal charge polarity of the toner,
wherein the cleaning bias applying portion is configured to apply the cleaning bias having a polarity opposite to the normal charge polarity of the toner to the brush during cleaning, and
wherein the control portion controls so as to apply the plurality of test biases to the brush when an area on the photosensitive member, which has passed through the charging position while the charging bias is applied to the charging device and which has passed through the transfer position while a predetermined bias, which is larger on the normal charge polarity side than the transfer bias to be applied by the transfer bias applying portion during image formation, is passing through the brush cleaning position.

5. The image forming apparatus according to claim 1, further comprising a pre-cleaning discharging device configured to perform a discharging process to eliminate at least a part of charge of the surface of the photosensitive member at a pre-cleaning discharging position downstream of the transfer position and upstream of the brush cleaning position with respect to the rotational direction of the photosensitive member,
wherein the control portion controls so as to apply the plurality of test biases to the brush when an area on the photosensitive member, which has passed through the charging position while the charging bias is applied to the charging device, which has passed through the transfer position while the transfer bias is not applied to the transfer device, and which has passed through the pre-cleaning discharging position while the discharging process is not performed by the pre-cleaning discharging device, is passing through the brush cleaning position.

6. The image forming apparatus according to claim 5, wherein the pre-cleaning discharging device performs the discharging process by irradiating the surface of the photosensitive member with a light.

7. The image forming apparatus according to claim 1, further comprising a memory portion configured to memorize usage history information correlating with an accumulated usage amount of the brush,
wherein the control portion controls to change a potential of the photosensitive member, just before passing through the brush cleaning position while the plurality of test biases are applied to the brush during the setting operation, based on the usage history information.

8. The image forming apparatus according to claim 7, wherein the control portion controls so that the potential of the photosensitive member, just before passing through the brush cleaning position while the plurality of test biases are applied to the brush during setting operation, becomes a first surface potential, in a case in which the accumulated usage amount of the brush indicated by the usage history information is a first usage amount, and controls so that the potential of the photosensitive member, just before passing through the brush cleaning position while the plurality of test biases are applied to the brush during setting operation, becomes a second surface potential larger on a normal charge polarity side than the first surface potential, in a case in which the accumulated usage amount of the brush indicated by the usage history information is a second usage amount larger than the first usage amount.

9. The image forming apparatus according to claim 7, wherein the control portion controls so as to change at least one of the plurality of test biases based on the usage history information.

10. The image forming apparatus according to claim 9, wherein when the accumulated usage amount of the brush indicated by the usage history information is a first usage amount and a second usage amount larger than the first usage amount, the control portion controls so that the largest test bias in absolute value of the plurality of test biases in a case in which the accumulated usage amount is the second usage amount becomes larger in absolute value than the the largest test bias in absolute value of the plurality of test biases in a case in which the accumulated usage amount is the first usage amount.

11. The image forming apparatus according to claim 9, wherein the control portion controls so that, in a case in which the accumulated usage amount of the brush indicated by the usage history information is a first amount, a difference between the plurality of test biases successively applied to the brush becomes a first difference, and controls so that, in a case in which the accumulated usage amount of the brush indicated by the usage history information is a second amount larger than the first amount, a difference between the plurality of test biases successively applied to the brush becomes a second difference lager than the first difference.

12. The image forming apparatus according to claim 8, wherein the control portion controls so that, in a case in which the accumulated usage amount indicated by the usage history information is a first usage amount, a number of the plurality of test biases becomes a first number, and controls so that, in a case in which the accumulated usage amount indicated by the usage history information is a second usage amount larger than the first usage amount, a number of the plurality of test biases becomes a second number larger than the first number.

13. The image forming apparatus according to claim 1, further comprising a pre-charging discharging device configured to perform a discharging process to eliminate at least a part of charge of the surface of the photosensitive member at a pre-charging discharging position downstream of the blade cleaning position and upstream of the charging position with respect to the rotational direction of the photosensitive member.

14. The image forming apparatus according to claim 13, wherein the pre-charging discharging device performs the discharging process by irradiating the surface of the photosensitive member with a light.
